(19) United States
(12) Patent Application Publication
(10) Pub. No.: US 2012/0107739 A1
(43) Pub. Date: May 3, 2012

(54) ELECTROSTATIC LATENT IMAGE DEVELOPER, IMAGE FORMING APPARATUS, PROCESS CARTRIDGE AND IMAGE FORMING METHOD

(75) Inventors: Takayuki YAMASHITA, Kanagawa (JP); Kazuhiko ARAI, Kanagawa (JP); Kunihiko SATO, Kanagawa (JP); Haruhide ISHIDA, Kanagawa (JP); Michio TAKE, Kanagawa (JP); Sakon TAKAHASHI, Kanagawa (JP); Fusako KIYONO, Kanagawa (JP); Yoshifumi IIDA, Kanagawa (JP); Mona TASAKI, Kanagawa (JP)

(73) Assignee: FUJI XEROX CO., LTD., TOKYO (JP)

(21) Appl. No.: 13/094,253

(22) Filed: Apr. 26, 2011

(30) Foreign Application Priority Data
Oct. 29, 2010 (JP) 2010-243542

(51) Int. Cl. G03G 15/09; G03G 21/00; G03G 21/18

(52) U.S. Cl. 430/119.82; 399/267; 399/111

(57) ABSTRACT

The present invention provides an electrostatic latent image developer used in an image forming apparatus including: an image holding member; a charging unit; a latent image forming unit; a developing unit which stores the electrostatic latent image developer and includes a developer holding member, wherein the developing unit develops the electrostatic latent image formed on the image holding member by bringing a magnetic brush, which is formed on a surface of the developer holding member by the electrostatic latent image developer, into contact with the image holding member, to form a toner image; a transfer unit; a cleaning unit; and a lubricant applying unit, wherein the electrostatic latent image developer contains a toner having a 50% integrated volume particle diameter of from 3.0 to 6.0 μm, and a carrier having a mean magnetization of 5.0×10⁻¹⁶ to 4.0×10⁻¹⁵ AM²/particle in an applied magnetic field of 1 kilo-oersted.

### CROSS-REFERENCE TO RELATED APPLICATION

This application is based on and claims priority under 35 USC 119 from Japanese Patent Application No. 2010-243542 filed Oct. 29, 2010.

### BACKGROUND

1. Technical Field

The present invention relates to an electrostatic latent image developer, an image forming apparatus, a process cartridge, and an image forming method.

2. Related Art

Electrophotography methods are widely utilized in copying machines, printers, and the like.

For example, there has been disclosed a technique of using a photoreceptor charger by applying voltage including an alternating current component, as a charging unit, also using a carrier having a saturation magnetization of from 40 emu/g to 80 emu/g with respect to an applied magnetic field of 1000 oersteds, as a carrier, and coating zinc stearate as a protective substance of an image holding member.

Moreover, there has been proposed a technique of supplying (coating) a lubricant (a material having a low surface energy) onto a surface of an image holding member, for the purpose of lowering the frictional coefficient between the image holding member and a cleaning blade, or for the purposes of reducing the non-electrostatic adhesion force between the image holding member and a toner to prevent fog.

### SUMMARY

According to an aspect of the invention, an electrostatic latent image developer used in an image forming apparatus including: an image holding member; a charging unit that charges a surface of the image holding member; a latent image forming unit that exposes the charged surface of the image holding member to form an electrostatic latent image; a developing unit which stores the electrostatic latent image developer and includes a developer holding member, wherein the developing unit develops the electrostatic latent image formed on the image holding member by bringing a magnetic brush, which is formed on a surface of the developer holding member by the electrostatic latent image developer, into contact with the image holding member, to form a toner image; a transfer unit that transfers the toner image formed on the image holding member to a recording medium; a cleaning unit including a cleaning blade that contacts with the surface of the image holding member and cleans the surface of the image holding member; and a lubricant applying unit that supplies a lubricant onto the surface of the image holding member, wherein the electrostatic latent image developer contains a toner having a volume average particle diameter of from approximately 3.0 μm to approximately 6.0 μm, and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted, is provided.

Here, the meaning of “fog” is “to become dirty” at a part of a recording medium such as copy paper or the like, which should be an unrecorded part (white part, unexposed part) under normal circumstances, due to undesirable attachment of the toner.

Exemplary embodiments based on the present invention include the following items <1> to <5>. However, the present invention is not limited thereto.

<1> An electrostatic latent image developer used in an image forming apparatus including: an image holding member; a charging unit that charges a surface of the image holding member; a latent image forming unit that exposes the charged surface of the image holding member to form an electrostatic latent image; a developing unit which stores the electrostatic latent image developer and includes a developer holding member, wherein the developing unit develops the electrostatic latent image formed on the image holding member by bringing a magnetic brush, which is formed on a surface of the developer holding member by the electrostatic latent image developer, into contact with the image holding member, to form a toner image; a transfer unit that transfers the toner image formed on the image holding member to a recording medium; a cleaning unit including a cleaning blade that contacts with the surface of the image holding member and cleans the surface of the image holding member; and a lubricant applying unit that supplies a lubricant onto the surface of the image holding member, wherein the electrostatic latent image developer contains a toner having a 50% integrated volume particle diameter (D50v) of from approximately 3.0 μm to approximately 6.0 μm, and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted.
<2> The electrostatic latent image developer according to the item <1>, wherein the toner includes toner particles containing a binder resin, a colorant, a release agent, and hydrophobicized silica particles as an external additive.
<3> The electrostatic latent image developer according to the item <2>, wherein the binder resin includes an amorphous polyester and a crystalline resin.
<4> The electrostatic latent image developer according to any one of the items <1> to <3>, wherein a 50% integrated volume particle diameter (D50v) of the carrier particles is in a range from approximately 15 μm to approximately 35 μm.
<5> The electrostatic latent image developer according to any one of the items <1> to <4>, wherein a ratio (D90v/D50v) of a 90% integrated volume particle diameter (D90v) of the carrier particles to a 50% integrated volume particle diameter (D50v) of the carrier particles is in a range from approximately 1.2 to approximately 1.4.
<6> The electrostatic latent image developer according to any one of the items <1> to <5>, wherein the carrier includes magnetic powder particles coated with resin.
<7> The electrostatic latent image developer according to the item <6>, wherein the magnetic powder includes a magnetic metal or a magnetic metal oxide.
<8> The electrostatic latent image developer according to the item <7>, wherein the magnetic metal oxide includes ferrite, ferric oxide, or magnetite.
<9> The electrostatic latent image developer according to any one of the items <1> to <8>, wherein the lubricant is selected from the group consisting of zinc stearate, calcium stearate, and low-molecular weight and high density polyethylene having a weight average molecular weight of 3,000 or less and a density of 0.96 or higher.
<10> An image forming apparatus including: an image holding member; a charging unit that charges a surface of the image holding member; a latent image forming unit that exposes the charged surface of the image holding member to form an electrostatic latent image; a developing unit which stores an electrostatic latent image developer containing a toner having a 50% integrated volume particle diameter (D50v) of from approximately 3.0 μm to approximately 6.0 μm and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted, and includes a developer holding member, wherein the developing unit develops the electrostatic latent image formed on the image holding member by bringing a magnetic brush, which is formed on a surface of the developer holding member by the electrostatic latent image developer, into contact with the image holding member, to form a toner image; a transfer unit that transfers the toner image formed on the image holding member to a recording medium; a cleaning unit including a cleaning blade which contacts with the surface of the image holding member and cleans the surface of the image holding member; and a lubricant applying unit that supplies a lubricant onto the surface of the image holding member.
<11> A process cartridge including: an image holding member; a developing unit which stores an electrostatic latent image developer containing a toner having a 50% integrated volume particle diameter (D50v) of from approximately 3.0 μm to approximately 6.0 μm and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted, and includes a developer holding member, wherein the developing unit develops an electrostatic latent image formed on the image holding member by bringing a magnetic brush, which is formed on a surface of the developer holding member by the electrostatic latent image developer, into contact with the image holding member, to form a toner image; a cleaning unit including a cleaning blade which contacts with the surface of the image holding member and cleans the surface of the image holding member; and a lubricant applying unit that supplies a lubricant onto the surface of the image holding member, wherein the process cartridge is attachable to and detachable from an image forming apparatus.
<12> An image forming method including: charging a surface of an image holding member; exposing the charged surface of the image holding member to form an electrostatic latent image; forming a magnetic brush on a developer holding member by using an electrostatic latent image developer containing a toner having a 50% integrated volume particle diameter (D50v) of from approximately 3.0 μm to approximately 6.0 μm and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted, and bringing the magnetic brush into contact with the image holding member to develop the electrostatic latent image formed on the image holding member, thereby forming a toner image; transferring the toner image formed on the image holding member to a recording medium; cleaning the surface of the image holding member by using a cleaning blade; and supplying a lubricant onto the surface of the image holding member.

### BRIEF DESCRIPTION OF THE DRAWINGS

Exemplary embodiments of the invention will be described in detail based on the following figures, wherein:

FIG. 1 is a schematic configuration diagram illustrating an image forming apparatus according to an exemplary embodiment;

FIG. 2 is a schematic configuration diagram illustrating an image forming apparatus according to an another exemplary embodiment;

FIG. 3 is a schematic diagrams illustrating an operation of a carrier for a developer according to the exemplary embodiment of the invention; and

FIG. 4 is a schematic diagrams illustrating an operation of a carrier for a conventional developer.

### DETAILED DESCRIPTION

Hereinafter, an exemplary embodiment which is one example of the present invention will be described.

The image forming apparatus according to an exemplary embodiment of the invention is equipped with an image holding member; a charging unit that charges a surface of the image holding member; a latent image forming unit that exposes the charged surface of the image holding member to form an electrostatic latent image; a developing unit which stores an electrostatic latent image developer and has a developer holding member, wherein the developing unit develops the electrostatic latent image formed on the image holding member by bringing a magnetic brush, which is formed on a surface of the developer holding member by the electrostatic latent image developer, into contact with the image holding member, to form a toner image; a transfer unit that transfers the toner image formed on the image holding member to a recording medium; a cleaning unit having a cleaning blade which contacts with the surface of the image holding member and cleans the surface of image holding member; and a lubricant applying unit that supplies a lubricant onto the surface of the image holding member.

Here, the magnetic brush consists of straight chain-like strings of plural carriers that are like ears standing on the surface of the developer holding member and toners adhering to the strings of plural carriers.

Further, as the electrostatic latent image developer (hereinafter, may be merely referred to as a “developer”), a developer containing a toner having a 50% integrated volume particle diameter (D50v) of from 3.0 μm to 6.0 μm or from approximately 3.0 μM to approximately 6.0 μm (hereinafter, may be referred to as a “small diameter toner”) and a carrier having a mean magnetization per one particle of from 5.0×10⁻¹⁶ AM²/particle to 4.0×10⁻¹⁵ AM²/particle or from approximately 5.0×10⁻¹⁶ AM²/particle to approximately 4.0×10⁻¹⁵ AM²/particle (hereinafter, may be referred to as a “low magnetization carrier”) in an applied magnetic field of 1 kilo-oersted is used.

Note that, the 50% integrated volume particle diameter (D50v) of a toner means the 50% integrated volume particle diameter (D50v) of toner particles which constitute the toner.

In recent years, a small diameter toner has been used in order to obtain a high resolution image. Since the small diameter toner has a smaller charging amount per one toner particle as the diameter becomes, smaller, electrostatic adhesion of the small diameter toner with respect to the image holding member becomes weaker, but on the contrary, non-electrostatic adhesion such as Van der Waals force (intermolecular force) with respect to the image holding member becomes stronger. Therefore, it is thought that it becomes difficult to perform transfer by a transfer electric field, as compared with a toner having a larger diameter, and as a result, fog is easily generated.

In order to suppress the generation of fog, a technique of supplying a lubricant onto a surface of an image holding member is known. The lubricant that has been supplied onto the surface of the image holding member may be spread over the surface by means of a cleaning blade arranged so as to be in contact with the surface of the image holding member, thereby forming a layer of the lubricant on the surface of the image holding member. It is thought that, according to the above operation, lowering of the surface energy of the surface of the image holding member may be achieved, the non-electrostatic adhesion between the image holding member and the toner may be reduced, and thus, the generation of fog may be suppressed.

However, under the existing circumstances, since the layer of the lubricant formed on the surface of the image holding member is, in a sense, only a layer formed by coating a lubricant, the layer is easily removed by, for example, being scratched with a mechanical burden or the like, and as a result, the function of the lubricant layer is not likely to be realized or not likely to be maintained.

In particular, in the case of using a small diameter toner, when the lubricant that has been supplied onto a surface of an image holding member is removed, the generation of fog may be remarkably realized, as the toner has a stronger non-electrostatic adhesion with respect to the image holding member.

The present inventors have examined the cause of the removal of this lubricant layer and have found that, in a contact development in which development is performed by bringing a magnetic brush formed by a developer into contact with an image holding member, the magnetic brush rubs the lubricant layer when the magnetic brush is in contact with the lubricant layer.

Further, the inventors have found that, this phenomenon occurs when the magnetic brush is hard to be crushed and is in a low density state, namely, when the carrier that forms the magnetic brush has a high mean magnetization per one particle (for example, a carrier having a mean magnetization per one particle of higher than 4.0×10⁻¹⁵ AM²/particle or approximately 4.0×10⁻¹⁵ AM²/particle; hereinafter, may be referred to as a “high magnetization carrier”).

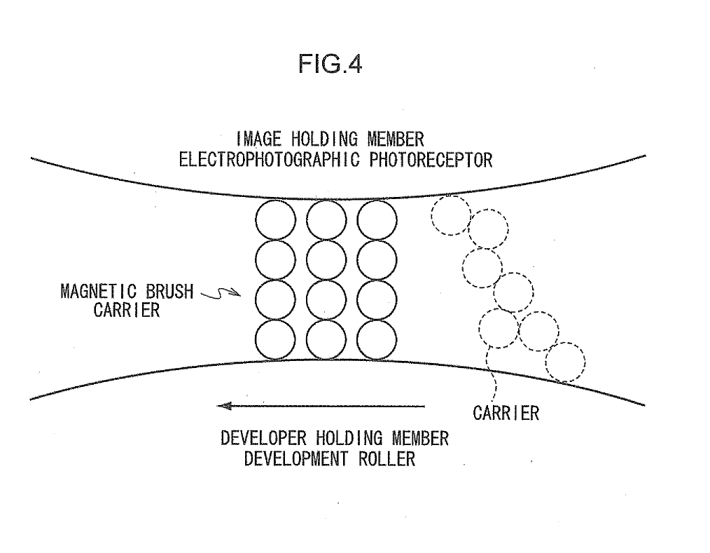

Here, in the case of using a high magnetization carrier, when the developer that is held by a developer holding member goes into the development region (a region where the developer holding member and the image holding member are arranged opposing each other), since the attractive force-like action between the carrier particles is great, disconnection or sliding of the string of carrier particles is less likely to occur in the development region. As a result, it is thought that the re-arrangement of the carrier particles is less likely to occur, and the magnetic brush becomes in a low density state (refer to FIG. 4). When the magnetic brush becomes in a low density state, the number of points of contact with the image holding member is decreased and thus, it is thought that the pressure of the magnetic brush against the image holding member becomes higher. Since the attractive force-like action between the carrier particles is great, it is thought that the magnetic brush becomes in a state of being hard to be crushed. Accordingly, it is thought that the abrasion force (force of rubbing) of the magnetic brush with respect to the surface of the image holding member tends to be stronger, to become easy to remove the lubricant that has been supplied onto the surface of the image holding member.

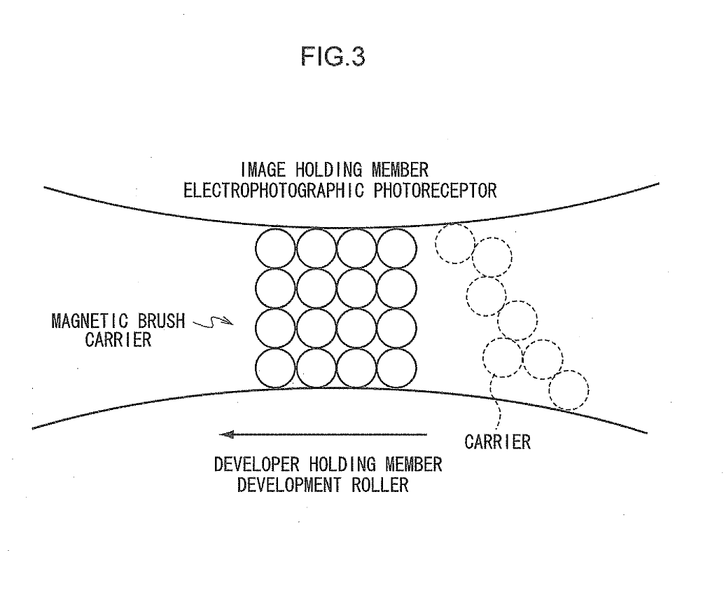

In contrast, as in the exemplary embodiment of the invention, in the case of using a low magnetization carrier, when the developer that is held by a developer holding member goes into the development region (a region where the developer holding member and the image holding member are arranged opposing each other), since the attractive force-like action between the carrier particles is small, disconnection or sliding of the string of carrier particles easily occurs in the development region. As a result, it is thought that the re-arrangement of the carrier particles becomes easy to occur, and the magnetic brush becomes in a high density state (refer to FIG. 3). When the magnetic brush becomes in a high density state, the number of points of contact with the image holding member is increased and thus, it is thought that pressure of the magnetic brush against the image holding member becomes weaker. Since the attractive force-like action between the carrier particles is small, it is thought that the magnetic brush becomes in a state of being easily crushed. Accordingly, it is thought that the abrasion force (force of rubbing) of the magnetic brush with respect to the surface of the image holding member tends to be weaker, and as a result, it becomes hard to remove the lubricant that has been supplied onto the surface of the image holding member.

It is thought that, these phenomena occur by mainly the cause of the degree of the strength of attractive force-like action, namely, mainly the cause of ease of disconnection or ease of sliding between the carrier particles. Therefore, it is thought that these phenomena may occur similarly, even if the distance between the developer holding member and the image holding member in the development region (DRS), the amount of the developer on the developer holding member (MOS), or the surface state (surface roughness) of the developer holding member is changed. Namely, not depending on DRS, MOS, or the surface state (surface roughness) of the developer holding member, in the case of using a low magnetization carrier, it is thought that the lubricant that has been supplied onto the surface of the image holding member becomes hard to be removed.

In the exemplary embodiment of the invention, a developer containing the low magnetization carrier described above is used as a developer, in an image forming apparatus equipped with a lubricant applying unit that supplies a lubricant onto a surface of an image holding member. By having such a configuration, it is thought that the lubricant that has been supplied onto the surface of the image holding member is hard to be removed, and reduction in the non-electrostatic adhesion between the image holding member and the toner and maintenance thereof may be realized. Therefore, even when a small diameter toner is used, an image in which the generation of fog is suppressed can be obtained.

Hereinafter, the exemplary embodiment of the invention is explained with reference to the drawings.

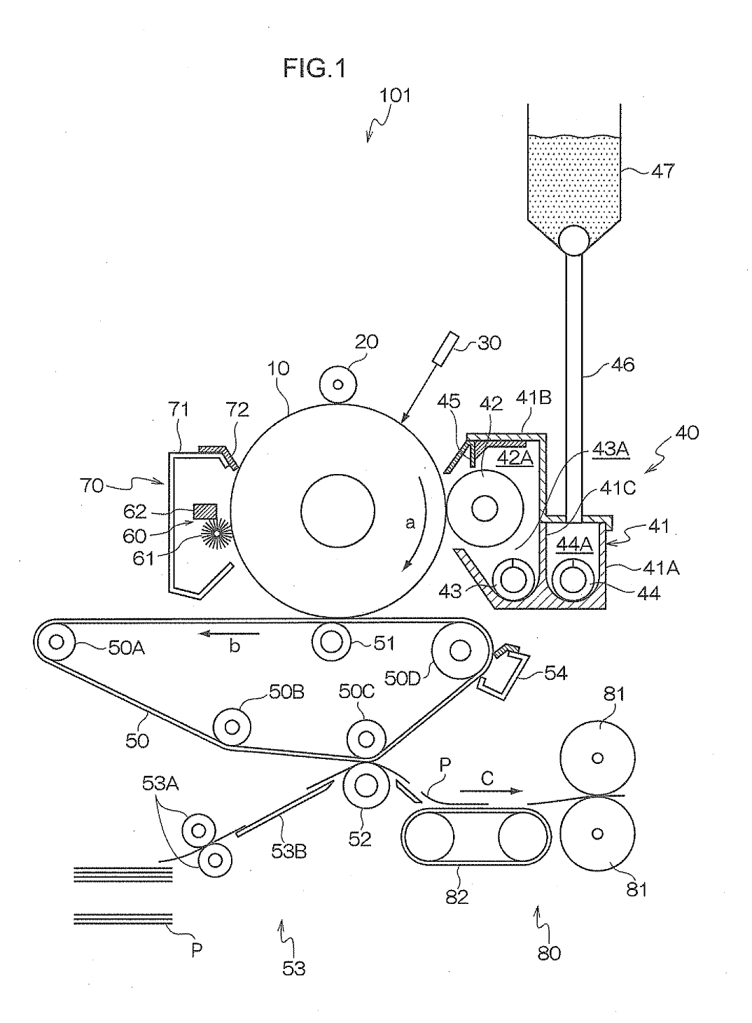

FIG. 1 is a schematic configuration diagram illustrating an image forming apparatus according to an exemplary embodiment of the invention.

As shown in FIG. 1, the image forming apparatus 101 according to the exemplary embodiment of the invention is equipped with an electrophotographic photoreceptor 10 (one example of the image holding member) that rotates, for example, in the clockwise direction, as indicated by an arrow a; a charging device 20 (one example of the charging unit) that is provided on the upper side of the electrophotographic photoreceptor 10 so as to face the electrophotographic photoreceptor 10 and charges the surface of the electrophotographic photoreceptor 10; a exposure device 30 (one example of the latent image forming unit) that exposes the surface of the electrophotographic photoreceptor 10 which is charged by the charging device 20, to form an electrostatic latent image; a developing device 40 (one example of the developing unit) that makes a toner contained in a developer adhere to the electrostatic latent image, which is formed by the exposure device 30, in accordance with a contact development method to form a toner image on the surface of the electrophotographic photoreceptor 10; a belt-shaped intermediate transfer body 50 that runs along a direction indicated by an arrow b, while being in contact with the electrophotographic photoreceptor 10 and transfers the toner image formed on the surface of the electrophotographic photoreceptor 10; and a cleaning device 70 (one example of the cleaning unit) that cleans the surface of the electrophotographic photoreceptor 10.

The charging device 20, the exposure device 30, the developing device 40, the intermediate transfer body 50, a lubricant applying device 60, and the cleaning device 70 are arranged on a circumference surrounding the electrophotographic photoreceptor 10 in the clockwise direction.

In the exemplary embodiment of the invention, a configuration in which the lubricant applying device 60 is arranged inside of the cleaning device 70 is explained; however, the invention is not limited thereto. A configuration in which the lubricant applying device 60 is arranged apart from the cleaning device 70 may be also adopted. There is no particular limitation on the arrangement position of the lubricant applying device 60 as long as the lubricant applying device can supply a lubricant onto the surface of the electrophotographic photoreceptor 10. For example, the lubricant applying device 60 may be preferably provided at the downstream side of a primary transferring device 51 in the rotation direction of the electrophotographic photoreceptor but at the upstream side of the cleaning device 70 (a cleaning blade 72 of the cleaning device) in the rotation direction of the electrophotographic photoreceptor.

The intermediate transfer body 50 is held, from the inside thereof, by supporting rollers 50A and 50B, a rare face roller 50C, and a driving roller 50D, while applying tension to the intermediate transfer body, and is driven in a direction indicated by the arrow b, accompanying the rotation of the driving roller 50D. A primary transferring device 51 is disposed on the inside of the intermediate transfer body 50 at the position facing the electrophotographic photoreceptor 10. The primary transferring device 51 charges the intermediate transfer body 50 so as to have a polarity different from the charge polarity of the toner, and makes the toner on the electrophotographic photoreceptor 10 adhere to the outer surface of the intermediate transfer body 50. A secondary transferring device 52 is disposed on the outside of the intermediate transfer body 50 in the lower position thereof, at the position opposing the rare face roller 50C. The secondary transferring device 52 charges a recording paper P (one example of the recording medium) so as to have a polarity different from the charge polarity of the toner, and transfers the toner image formed on the intermediate transfer body 50 onto the recording paper P. Note that, these members which are used for transferring the toner image formed on the electrophotographic photoreceptor 10 onto the recording paper P correspond to one example of the transfer unit.

Further, on a lower side of the intermediate transfer body 50, a recording paper applying device 53 that supplies the recoding paper P to the secondary transferring device 52, and a fixing device 80 that fixes the toner image while conveying the recoding paper P, on which the toner image has been formed in the secondary transferring device 52, are provided.

The recording paper applying device 53 is equipped with a pair of conveying rollers 53A and a leading board 53B that leads the recording paper P conveyed by the conveying rollers 53A toward the secondary transferring device 52. On the other hand, the fixing device 80 has fixing rollers 81, which are a pair of heat rollers that perform fixation of the toner image by heating and pressing the recording paper P onto which the toner image has been transferred by the secondary transferring device 52, and a conveying belt 82 that conveys the recording paper P toward the fixing rollers 81.

The recording paper P is conveyed in a direction indicated by an arrow c by the recording paper applying device 53, the secondary fixing device 52, and the fixing device 80.

The intermediate transfer body 50 further includes an intermediate transfer body cleaning device 54. The intermediate transfer body cleaning device 54 has a cleaning blade that removes a toner remaining on the intermediate transfer body 50, after the toner image has been transferred to the recording paper P in the secondary transferring device 52.

Hereinafter, the main constituent members in the image forming apparatus 101 according to the exemplary embodiment of the invention are described in detail.

Developer

The developer is a two-component developer containing a toner and a carrier. As the carrier, the low magnetization carrier described above is used.

First, the description will be made of a toner.

The toner may include toner particles containing a binder resin, a colorant, and if necessary, other additives such as a release agent, and if necessary, an external additive.

The description will be made of toner particles (toner base particles). The binder resin is not particularly limited, but examples thereof include: homopolymers and copolymers formed of monomers such as styrenes (such as styrene, chlorostyrene, or the like), monoolefins (such as ethylene, propylene, butadiene, isoprene, or the like); vinyl esters (such as vinyl acetate, vinyl propionate, vinyl benzoate, vinyl butyrate, or the like); α-methylenylaliphatic monocarboxylic acid esters (such as methyl acrylate, ethyl acrylate, butyl acrylate, dodecyl acrylate, octyl acrylate, phenyl acrylate, methyl methacrylate, ethyl methacrylate, butyl methacrylate, dodecyl methacrylate, or the like); vinyl ethers (such as vinyl methyl ether, vinyl ethyl ether, vinyl butyl ether, or the like); vinyl ketones (such as vinyl methyl ketone, vinyl hexyl ketone, vinyl isopropenyl ketone, or the like) or the like, and polyesters formed by co-condensation of dicarboxylic acids and diols.

Typical specific example of the binder resin includes polystyrene, styrene-alkyl acrylate copolymer, styrene-alkyl methacrylate copolymer, styrene-acrylonitrile copolymer, styrene-butadiene copolymer, styrene-maleic anhydride copolymer, polyethylene, polypropylene, polyester, and the like. Further, the typical specific example of the binder resin includes polyurethane, epoxy resin, silicone resin, polyamide, denatured rosin, paraffin wax, and the like.

Examples of the colorant include those represented by magnetic powder (for example, magnetite, ferrite, or the like), carbon black, aniline blue, Calco Oil Blue, chrome yellow, ultramarine blue, Du Pont oil red, quinoline yellow, methylene blue chloride, phthalocyanine blue, malachite green oxalate, lamp black, rose bengal, C.I. Pigment Red 48:1, C.I. Pigment Red 122, C.I. Pigment Red 57:1, C.I. Pigment Yellow 97, C.I. Pigment Yellow 17, C.I. Pigment Blue 15:1, C.I. Pigment Blue 15:3, or the like.

Among them, preferable examples of yellow colorant include monoazo-based pigments such as C. I. Pigment Yellow 74, C. I. Pigment Yellow 1, 2, 3, 5, 6, 49, 65, 73, 75, 97, 98, 111, 116, 130 and the like; condensed disazo-based pigments such as C. I. Pigment Yellow 93, C. I. Pigment Yellow 94, 95, 128, 166 and the like; anthraquinone-based pigments such as C. I. Pigment Yellow 147, C. I. Pigment Yellow 24, 108, 193, 199 and the like; and disazo-based pigments such as C. I. Pigment Yellow 12, 13, 14, 17, 55, 63, 81, 83, 87, 90, 106, 113, 114, 121, 124, 126, 127, 136, 152, 170, 171, 172, 174, 176, 188 and the like.

Further, preferable examples of magenta colorant include β-naphthol-based pigments such as C. I. Pigment Red 146, C. I. Pigment Red 2, 5, 7, 8, 9, 10, 11, 12, 13, 14, 15, 16, 17, 18, 21, 22, 23, 31, 32, 95; 112, 114, 119, 136, 147, 148, 150, 164, 170, 184, 187, 188, 210, 212, 213, 222, 223, 238, 245, 253, 256, 258, 261, 266, 267, 268, 269, and the like; azo lake-based pigments such as C. I. Pigment Red 57:1, C. I. Pigment Red 18:1, 48:2, 48:3, 48:4, 48:5, 50:1, 51, 52:1, 52:2, 53:1, 53:2, 53:3, 58:2, 58:4, 64:1, 68, 200, and the like; quinacridone-based pigments such as C. I. Pigment Red 209, C. I. Pigment Red 122, 192, 202, 207, C. I. Pigment Violet 19, and the like; disazo-based pigments such as C. I. Pigment Red 37, 38, 41, 111, C. I. Pigment Orange 13, 15, 16, 34, 44, and the like; and condensed disazo-based pigments such as C. I. Pigment Red 144, 166, 214, 220, 221, 242, 248, 262, C. I. Pigment Orange 31, and the like.

The yellow pigments and magenta pigments are easily charged negatively with respect to the carrier and thus, as a result, the charging amount of the toner may be adjusted to be uniform to some extent, so that the generation of fog may by suppressed more easily.

Other additive agent includes, for example, a release agent, a magnetic substance, a charge control agent, and an inorganic powder.

Examples of the release agent include, but not limited to: hydrocarbon wax; natural wax such as carnauba wax, rice wax, or candelilla wax; synthesized or mineral and petroleum wax such as montan wax; and ester wax such as fatty acid ester or montanic acid ester.

Properties of toner particles are explained below.

An average shape factor is a number average of the shape factor Sf which is represented by the following Formula:

Sf=(ML²/A)×(π/4)×100

wherein, ML represents a maximum length of a particle, and A represents a value of projected area of the particle. An average shape factor of toner particles is preferably in a range of 100 to 150, more preferably in a range of 105 to 145, and even more preferably in a range of 110 to 140.

A 50% integrated volume particle diameter (D50v) of the toner particles is preferably in a range of 3.0 μm to 6.0 μm or approximately 3.0 μm to approximately 6.0 μm, and more preferably in a range of 3.2 μm to 6.0 μm or approximately 3.2 μm to approximately 6.0 μm. When the 50% integrated volume particle diameter (D50v) of the toner particles is in the above range, generation of fog in an image developed with the toner is suppressed.

A measurement procedure of the 50% integrated volume particle diameter (D50v) of the toner particles is as following.

Specifically, in preparation of the measurement sample of the 50% integrated volume particle diameter (D50v) of the toner particles, 0.5 mg to 50 mg of a sample to be measured is added to 2 mL of a 5% aqueous solution containing a surfactant (preferably sodium alkylbenzene sulfonate), as a dispersing agent, and the resultant is added to 100 mL to 150 mL of an electrolyte aqueous solution (ISOTON solution (registered trademark) manufactured by Beckman Coulter Inc.). The electrolyte solution containing the sample suspended therein is subjected to a dispersion treatment using an ultrasonic disperser for approximately 1 minute, and then the size distribution of particles is measured. The measurement of the 50% integrated volume particle diameter (D50v) of the toner particles is carried out by measuring particle size distribution of particles in a range of from 2.0 μm to 60 μm using COULTER MULTISIZER II (trade name, manufactured by Beckman Coulter Inc.) with an aperture diameter of 100 μm. The number of particles to be measured is 50,000.

The obtained size distribution of the particles is accumulated to draw a cumulative volume distribution from the smallest particle diameter for divided particle size ranges (channels), and the particle diameter corresponding to 50% in the cumulative volume distribution is defined as the 50% integrated volume particle diameter (D50v) (in some cases, it may be merely referred as integrated volume particle diameter D50v, particle diameter D50v, or D50v).

The external additive is explained below. As the external additive, inorganic particles are exemplified. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄ and MgSO₄.

The surface of the external additive may be subjected to a hydrophobization treatment in advance. The hydrophobization treatment is carried out by, for example, immersing the inorganic particles in a hydrophobization treating agent, or the like. The hydrophobization treating agent is not particularly limited, but examples of the hydrophobization treating agent include a silane-based coupling agent, silicone oil, a titanate-based coupling agent, an aluminum-based coupling agent, and the like. These may be used singly, or in a combination of two or more kinds thereof.

A production method of the toner particles is explained below. Although the production method of the toner particles is not particularly limited, the toner particles may be produced, for example, by a kneading and pulverizing method in which a binder resin, a colorant, a release agent, and if necessary, a charge control agent, for example, are added, and the resultant mixture is kneaded, pulverized and classified; a method in which the shapes of the particles obtained by the kneading and pulverizing method are changed by a mechanical impact force or a thermal energy; an emulsion polymerization and aggregation method in which an emulsion polymerization of polymerizable monomers of a binder resin is caused, the thus formed dispersion liquid and a dispersion liquid of a colorant, a release agent, and if necessary, a charge control agent, for example, are mixed, aggregated, and heat-melted to obtain the toner particles; a suspension polymerization method in which polymerizable monomers to obtain a binder resin, a colorant, a release agent, and if necessary, a charge control agent, for example, are suspended and polymerized in an aqueous solvent; and a dissolution suspension method in which a binder resin, a colorant, a release agent, and if necessary a charge control agent, for example, are suspended in an aqueous solvent to granulate the toner particles.

In addition, a known method such as a production method for causing the particles to have a core shell structure by further making aggregated particles adhere to the toner particles, which have been obtained by one of the above methods, as cores and thermally fusing the resultant mixture is employed. In addition, the suspension polymerization method for producing the toner using an aqueous solvent, the emulsion polymerization and aggregation method, and the dissolution suspension method may be used, and the emulsion polymerization and aggregation method may be used, from the viewpoint of controlling the shapes and the particle size distribution.

Then, the toner is produced by mixing the above toner particles and the above external additive using a Henschel mixer, or a V-blender, for example. In addition, when the toner particles are produced in a wet manner, the external additive may be externally added in a wet manner.

Next, the carrier is explained below.

The carrier is a carrier having a mean magnetization per one carrier particle of from 5.0×10⁻¹⁶ AM²/particle to 4.0×10⁻¹⁵ AM²/particle or from approximately 5.0×10⁻¹⁶ AM²/particle to approximately 4.0×10⁻¹⁵ AM²/particle (preferably, from 7.0×10⁻¹⁶ AM²/particle to 4.0×10⁻¹⁵ AM²/particle or from approximately 7.0×10⁻¹⁶ AM²/particle to approximately 4.0×10⁻¹⁵ AM²/particle) in an applied magnetic field of 1 kilo-oersted.

It should be noted that 1 [oersted: Oe]=10³/4π[A/m].

When the mean magnetization is less than approximately 5.0×10⁻¹⁶ AM²/particle, the attractive force-like action between the carrier particles is too weak, so that disconnection or re-arrangement of the magnetic brush may occur at the surface layer of the magnetic brush (at the side that contacts with the image holding member). As a result, developing property may be deteriorated and also, scattering of carrier may be caused. When the mean magnetization exceeds approximately 4.0×10⁻¹⁵ AM²/particle, the lubricant that has been supplied onto the surface of the image holding member may be removed, as described above, and disorder of the toner image may be caused.

Here, the mean magnetization us per one carrier particle in an applied magnetic field of 1 kilo-oersted is represented by the following Formula.

Formula σs=σ×4πr³ρ/(3×10¹²)

σ: the magnetization (AM²/kg) of the carrier

r: the 50% integrated volume particle diameter (D50v) (μm) of the carrier

ρ: the true specific gravity (g/cm³) of the carrier (core material, in the case of a coated carrier).

Herein, the magnetization (AM²/kg) of the carrier is expressed by the value determined as follows.

In the magnetic field of 1 k (10³/4π·A/m)=1 kOe, the magnetization (AM²/kg) of the carrier is measured using a VSM (vibration sample method) measuring instrument in accordance with a B-H Tracer method. A vibration sample type magnetometer VSM P10 (trade name, manufactured by Toei Industry Co., Ltd.) is used as the measuring instrument.

The 50% integrated volume particle diameter (D50v) of the carrier is preferably from 15 μm to 35 μm or from approximately 15 μm to approximately 35 μm.

Further, with regard to the particle size distribution of the carrier, the relationship between the 50% integrated volume particle diameter (D50v) and the 90% integrated volume particle diameter (D90v) (in some cases, it may be merely referred as integrated volume particle diameter D90v, particle diameter D90v, or D90v) preferably satisfies 1.4≧D90v/D50v≧1.2, and more preferably satisfies 1.35≧D90v/D50v≧1.2.

When the relationship between the integrated volume particle diameter D50v and the integrated volume particle diameter D90v satisfies the above range, disorder of the toner image which is formed on the electrophotographic photoreceptor 10 may be suppressed. The reason for this is thought as follows. That is, the mean magnetization per one carrier particle has a tendency of getting greater, as the particle diameter of the carrier gets larger. Therefore, in the carrier having a broad particle size distribution, the magnetization distribution also gets broader, and as a result, unevenness in the hardness of the magnetic brush may be easily generated. In contrast, when the particle size distribution of the carrier is within the above range, a relatively hard and stable structure may be formed at the base (at the side of the developing roll) of the magnetic brush by large-diameter particles, while a relatively soft and flexible structure may be formed at the tip (at the side of the electrophotographic photoreceptor) of the magnetic brush by small-diameter particles, whereby the disorder of the toner image may be suppressed.

Measurement procedures of the integrated volume particle diameter D50v and D90v of the carrier are as follows.

First, 0.5 mg to 50 mg of a sample to be measured are added to 2 mL of a 5% by weight aqueous solution of a surfactant (preferably, sodium alkylbenzene sulfonate) as a dispersing agent, and the resultant is added to 100 mL to 150 mL of an electrolyte liquid. The electrolyte liquid containing the sample to be measured suspended therein is subjected to a dispersion treatment using an ultrasonic disperser for approximately one minute. Then, the particle size distribution of particles having a particle diameter in a range of from 2.0 μm to 60 μm is measured using COULTER MULTISIZER II (trade name, manufactured by Beckman Coulter Inc.) with an aperture diameter of 100 p.m. The number of particles to be measured is 50,000.

The obtained particle size distribution is accumulated to draw a cumulative volume distribution from the smallest diameter for divided particle size ranges (channels), and the particle diameter corresponding to 50% in the cumulative volume distribution is defined as the integrated volume particle diameter D50v. Further, the particle diameter corresponding to 90% in the cumulative volume distribution is defined as the integrated volume particle diameter D90v.

The true specific gravity of the carrier (core material, in the case of a coated carrier) is preferably, for example, from 2.0 g/cm³ to 5.5 g/cm³.

The true specific gravity of the carrier is expressed by the value determined in a manner described below.

In the case of a coated carrier, the true specific gravity p of the carrier may be adjusted by, for example, the kind, the size, and the like of the magnetic powder to be used. Further, in the case of a magnetic powder dispersed type carrier, the true specific gravity p of the carrier may be adjusted by, for example, the kind, the amount, and the like of the magnetic powder to be used.

The true specific gravity (g/cm³) of the carrier (core material, in the case of a coated carrier) is expressed by the value measured by performing the following operation in accordance with JIS-K-0061, 5-2-1, using a Le Chatelier specific gravity bottle.

(1) Approximately 250 mL of ethyl alcohol is placed in a Le Chatelier specific gravity bottle, and the meniscus is adjusted to be positioned at a scale mark,

(2) The specific gravity bottle is immersed into a constant-temperature water bath, and when the liquid temperature reaches 20.0° C.±0.2° C., the position of the meniscus is accurately read utilizing the scale mark of the specific gravity bottle (precision is 0.025 mL).

(3) Approximately 100 g of a sample is weighed.

(4) The weighed sample is introduced into the specific gravity bottle, and bubbles are removed.

(5) The specific gravity bottle is immersed into a constant-temperature water bath, and when the liquid temperature reaches 20.0° C.±0.2° C., the position of the meniscus is accurately read utilizing the scale mark of the specific gravity bottle (precision is 0.025 mL).

(6) The true specific gravity is calculated according to the following Formulae.

Formula D=W/(L2−L1)

Formula S=D/0.9982

In the Formulae, D is the density (g/cm³, at 20° C.) of the sample; S is the true specific gravity (at 20° C.) of the sample; W is the apparent weight (g) of the sample; L1 is the reading value (mL, at 20° C.) of the meniscus before the sample is introduced into the specific gravity bottle; L2 is the reading value (mL, at 20° C.) of the meniscus after the sample is introduced into the specific gravity bottle; and 0.9982 is the density (g/cm³) of water at 20° C.

Specifically, examples of the carrier include a coated carrier which is obtained by coating a surface of a core material formed from magnetic powder with a coating resin, and a magnetic powder dispersed type carrier which is obtained by dispersing and blending magnetic powder in a matrix resin.

Note that, the magnetic powder dispersed type carrier may include a carrier which is obtained by using, as a core material, a resin particle containing magnetic powder dispersed and blended in a matrix resin, and coating the core material with a coating resin.

Examples of the magnetic powder include magnetic metals such as iron, nickel, and cobalt, and magnetic metal oxides such as iron oxide, ferrite and magnetite.

Examples of the coating resin used for coating the core material or the matrix resin used for dispersing and blending the magnetic powder include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin including an organosiloxane bond or a modified product thereof, a fluororesin, polyester, polycarbonate, a phenol resin, and an epoxy resin.

Further, other additives such as an electrically conductive material or the like may be added to the coating resin used for coating the core material or the matrix resin used for dispersing and blending the magnetic powder.

Examples of a method of coating the coating resin on the surface of the core material include a method of coating with a solution for forming a coating layer, which is prepared by dissolving a coating resin and, as necessary, various additives in a proper solvent. The solvent is not particularly limited and may be selected in consideration of the coating resin to be used, coating suitability, and the like.

Specific examples of the resin coating method include a dipping method in which a core material is dipped in a solution for forming a coating layer; a spray method in which a solution for forming a coating layer is sprayed onto a surface of a core material; a fluidized bed method in which a solution for forming a coating layer is sprayed to a core material, which is made to float with a fluidizing air; and a kneader coater method in which a core material of a carrier and a solution for forming a coating layer are mixed in a kneader coater, followed by removing the solvent.

Here, elements in the magnetic powder as the core material may exert influence on the charging distribution of the developer. Specifically, copper elements may broaden the charging amount distribution of the toner by aging, and may make fog to be generated easily. Therefore, from the viewpoint of maintaining the charging amount distribution of the toner, the amount of copper elements with respect to the whole carrier is preferably 1000 ppm or less, more preferably 500 ppm or less, and even more preferably 100 ppm or less.

The amount of copper elements with respect to the whole carrier can be measured by using a fluorescent X-ray.

The measurement of fluorescent X-ray is performed using a fluorescent X-ray analyzer (trade name: XRF-1500, manufactured by Shimadzu Corporation) under the measuring conditions of a tube voltage of 40 KV, a tube current of 90 mA, and a measuring time of 30 minutes.

In the developer, the mixing ratio (ratio by weight) of the toner and the carrier (toner:carrier) is, for example, in a range of from approximately 1:100 to approximately 30:100.

Electrophotographic Photoreceptor

Examples of the electrophotographic photoreceptor 10 include an inorganic photoreceptor in which the photosensitive layer provided on an electrically conductive substrate is formed from an inorganic material, and an organic photoreceptor in which the photosensitive layer is formed from an organic material. Examples of the organic photoreceptor include a function separated type photoreceptor in which a charge generating layer that generates charges by electrically conductive exposure and a charge transport layer that transports the charges are laminated on an electrically conductive substrate, and a photoreceptor in which a single layer type photosensitive layer that has a function of generating charges and a function of transporting the charges in the same layer is provided on an electrically conductive substrate. Examples of the inorganic photoreceptor include a photoreceptor in which a photosensitive layer formed from amorphous silicon is provided on an electrically conductive substrate.

The shape of the electrophotographic photoreceptor 10 is not limited to a cylindrical shape, and, for example, a known shape such as a sheet shape, a plate shape, or the like may be adopted.

Charging Device

Examples of the charging device 20 include a contact type charger using a conductive charge roller, a charge brush, a charge film, a charge rubber blade, or a charge tube, for example. In addition, examples of the charging device 20 also include, for example, a charger, which has been already known, such as a non-contact type roller charger, a scorotron charger using corona discharge, or a corotron charger. In exemplary embodiments, the scorotron charger using corona discharge may be preferably used as the charging device 20.

Exposure Device

Examples of the exposure device 30 include optical equipment, for example, for exposing the surface of the electrophotographic photoreceptor 10 with semiconductor laser light, LED light beam, or liquid crystal shutter light, for example, in the form of an image. The wavelength of the light source may be in the spectral sensitivity region of the electrophotographic photoreceptor 10. As for the wavelength of the semiconductor laser, a near-infrared laser having an oscillation wavelength near 780 nm may be used. However, the wavelength is not limited thereto, and a laser having an oscillation wavelength of from 600 nm to less than 700 nm or a laser having an oscillation wavelength from 400 nm to 450 nm as a blue laser may also be used. In addition, as the exposure device 30, it is also effective to use a surface-emitting laser light source which outputs multi beams in order to form a color image.

Developing Device The developing device 40 is arranged, for example, so as to oppose the eletrophotographic photoreceptor 10 in the development region. The developing device 40 has, for example, a developer container 41 (the main body of the developing device) that stores therein a developer (two-component developer) containing a toner and a carrier, and a replenishment developer storing container (toner cartridge) 47. The developer container 41 has a developer container main body 41A and a developer container cover 41B that covers the upper edge of the developer container main body.

The developer container main body 41A has, for example, on its inner side, a developing roll chamber 42A that stores a developing roll (one example of the developer holding member) 42 and has a first stirring chamber 43A adjacent to the developing roll chamber 42A, and a second stirring chamber 44A adjacent to the first stirring chamber 43A. Further, in the developing roll chamber 42A, for example, a layer thickness restricting member 45 is provided to restrict the layer thickness of the developer on the surface of the developing roll 42 when the developer container main body 41A is covered with the developer container cover 41B.

For example, the first stirring chamber 43A and the second stirring chamber 44A are divided by, for example, a partition wall 41C. Though not shown, openings are provided at the two edge portions in the longitudinal direction of the partition wall 41C so that the first stirring chamber 43A and the second stirring chamber 44A are connected. The first stirring chamber 43A and the second stirring chamber 44A constitutes a circulating stirring chamber (43A+44A).

In the developing roll chamber 42A, the developing roll 42 is arranged so as to oppose the electrophotographic photoreceptor 10. In the developing roll 42, though not shown, a sleeve is provided at the outside of a magnetic roll (fixed magnet) having magnetism. The developer in the first stirring chamber 43A is adsorbed on the surface of the developing roll 42 by the magnetic force of the magnetic roll, and conveyed to the development region. Note that, the developing roll 42 is supported with the developer container main body 41A such that the roll axis of the developing roll is freely rotatable. Here, the developing roll 42 rotates in a rotation direction opposite from the rotation direction of the electrophotographic photoreceptor 10, and at the opposing portion, the developer that has been adsorbed on the surface of the developing roll 42 is conveyed to the development region along the same direction as the moving direction of the electrophotographic photoreceptor 10.

Further, a bias power source (not shown) is connected to the sleeve of the developing roll 42 so that a developing bias is to be applied. (In the exemplary embodiment of the invention, a bias in which an alternating current component (AC) is superposed on the direct current component (DC) is applied, in order to apply an alternating electric field to the development region.)

In the first stirring chamber 43A and the second stirring chamber 44A, a first stirring member 43 (stirring and conveying member) and a second stirring member 44 (stirring and conveying member) which stir and convey the developer are arranged. The first stirring member 43 includes a first rotation axis that stretches toward the axis direction of the developing roll 42, and stirring and conveying blades (protruding portions) that are fixed in a spiral state on the outer circumference of the rotation axis. Similarly, the second stirring member 44 includes a second rotation axis and stirring and conveying blades (protruding portions). Note that, the stirring members are supported with the developer container main body 41A so as to rotate freely. The first stirring member 43 and the second stirring member 44 are disposed such that, by their rotation, the developer in the first stirring chamber 43A and the developer in the second stirring chamber 44A are each conveyed in the opposite direction from each other.

To one edge side in the of the longitudinal direction of the second stirring chamber 44A, one end of a supply conveying path 46 is connected. The supply conveying path 46 is used for supplying a developer for replenishment, which contains a toner for replenishment and a carrier for replenishment, to the second stirring chamber 44A. To the other end of the supply conveying path 46, the replenishment developer storing container 47 that stores the developer for replenishment is connected.

As described above, in the developing device 40, the developer for replenishment is supplied from the replenishment developer storing container (toner cartridge) 47 via the supply conveying path 46 to the developing device 40 (second stirring chamber 44A).

Transferring Device

Examples of the primary transferring device 51 and the secondary transferring device 52 include a transferring charger, which is already known, such as a contact type transferring charger using a belt, a roller, a film, or a rubber blade, a scorotron transferring charger using corona discharge, and a corotron charger.

As the intermediate transfer body 50, a belt-shaped intermediated transfer body (intermediate transfer belt) formed from polyimide, polyamideimide, polycarbonate, polyarylate, polyester, rubber, or the like, each of which contains an electrically conductive agent, is used. Further, regarding the form of the intermediate transfer body, a cylindrical intermediated transfer body, other than a belt-shaped intermediated transfer body, may be used.

Cleaning Device

The cleaning device 70 includes a case body 71, a cleaning blade 72 which is disposed so as to protrude from the case body 71, and a lubricant-applying device 60 arranged at the upstream side of the cleaning blade 72 in the rotation direction of the electrophotographic photoreceptor 10. In addition, the cleaning blade 72 may have a configuration supported with an edge portion of the case body 71, or a configuration supported with an alternative holder member. In exemplary embodiment of the invention, the cleaning blade 72 is illustrated as a configuration supported with an edge portion of the case body 71.

First, the cleaning blade 72 is explained.

The cleaning blade 72 is a plate-shaped substance stretching in the direction along the rotation axis of the electrophotographic photoreceptor 10. The cleaning blade 72 is provided such that the tip portion of the cleaning blade is pressed against the surface of the electrophotographic photoreceptor 10 so as to be toward the upstream side in the rotation direction (indicated by the arrow a) of the electrophotographic photoreceptor 10, and contacts with the surface of the electrophotographic photoreceptor 10.

Examples of the material that forms the cleaning blade 72 include urethane rubber, silicone rubber, fluorine-containing rubber, propylene rubber, and butadiene rubber. Among them, urethane rubber is preferable.

The urethane rubber (polyurethane) is not particularly limited as long as it is conventionally used for forming polyurethane. For example, those prepared by using, as raw materials, a urethane prepolymer fowled from a polyol such as a polyester polyol such as polyethylene adipate or polycaprolactone and isocyanate such as diphenylmethane diisocyanate, and a crosslinking agent, for example, 1,4-butanediol, trimethylolpropane, ethylene glycol, a mixture thereof, or the like are preferable.

Next, the lubricant applying device 60 is explained.

The lubricant applying device 60 is arranged, for example, inside the cleaning device 70, and at the upstream side of the cleaning blade 72 in the rotation direction of the electrophotographic photoreceptor 10.

The lubricant applying device 60 includes, for example, a revolving brush 61 that is arranged so as to be in contact with the electrophotographic photoreceptor 10, and a solid state lubricant 62 that is arranged so as to be in contact with the revolving brush 61. In the lubricant applying device 60, when the revolving brush 61 revolves in the state of being in contact with the solid state lubricant 62, the lubricant 62 adheres to the revolving brush 61, and the adhered lubricant 62 is supplied to the surface of the electrophotographic photoreceptor 10, whereby a film of the lubricant 62 is formed.

It should be noted that the configuration of the lubricant applying device 60 is not limited to the above. For example, the lubricant applying device 60 may have a configuration in which a rubber roller is used in place of the revolving brush 61.

Examples of the lubricant 62 include metal soap and wax. An example of the metal soap is zinc stearate. An example of the wax is polyethylene wax. Examples of the metal soap as the lubricant 42 include, in addition to zinc stearate, fatty acid metal salts such as barium stearate, lead stearate, ferrous stearate, nickel stearate, cobalt stearate, copper stearate, strontium stearate, calcium stearate, cadmium stearate, magnesium stearate, zinc oleate, manganese oleate, ferrous oleate, cobalt oleate, lead oleate, magnesium oleate, copper oleate, zinc palmitate, cobalt palmitate, copper palmitate, magnesium palmitate, aluminum palmitate, calcium palmitate, lead caprylate, lead caproate, zinc linolenate, cobalt linolenate, calcium linolenate, and cadnium linolenate. Other than the above, for example, colloidal high temperature silica powder such as CAB-O-S11 (trade name), which is commercially available from Cabot Corporation, may be described. Examples of the wax include, in addition to polyethylene wax, ester wax, polypropylene, polyethylene/polypropylene copolymers, natural waxes such as carnauba wax, polyglycerin wax, microcrystalline wax, paraffin wax, sazole wax, montanic ester wax, deoxidated carnauba wax; palmitic acid, stearic acid, montanic acid; unsaturated fatty acids such as brandinic acid, eleostearic acid, and parinaric acid; saturated alcohols such as stearyl alcohol, aralkyl alcohol, behenyl alcohol, carnaubyl alcohol, ceryl alcohol, melissyl alcohol, and long chain alkyl alcohols having an alkyl group with a longer chain; polyhydric alcohols such as sorbitol; fatty acid amides such as linolic acid amide, oleic acid amide, and lauric acid amide; saturated fatty acid bisamides such as methylenebisstearic acid amide, ethylenebiscapric acid amide, ethylenebislauric acid amide, and hexamethylenebisstearic acid amide; unsaturated fatty acid amides such as ethylenebisoleic acid amide, hexamethylenebisoleic acid amide, N,N′-dioleyladipic acid amide, and N,N′-dioleylsebacic acid amide; aromatic bisamides such as m-xylenebisstearic acid amide, N,N′-distearylisophthalic acid amide; waxes obtained by grafting aliphatic hydrocarbon waxes using vinyl monomers such as styrene or acrylic acid; partially esterified compounds of fatty acids and polyhydric alcohols, such as behenic acid monoglyceride; and methyl esterified compounds having a hydroxy group, obtained by hydrogenation of vegetable fats and oils.

Among them, zinc stearate, calcium stearate, and low-molecular weight and high density polyethylene having a weight average molecular weight of 3,000 or less and a density of 0.96 or higher are preferred.

Furthermore, as the lubricant, for example, a fluororesin (for example, polytetrafluoroethylene (PTFE), or the like) is also described, and a mixture of zinc stearate and a fluororesin is also preferably described.

Examples of the fiber of the revolving brush 61 include resin fibers such as nylon, acryl, polypropylene, and polyester.

For example, a revolving brush 61 having a fiber density of from 15×10³ fibers/inch to 120×10³ fibers/inch² (from 23.4 fibers/mm² to 186 fibers/mm²), a fiber length of from 1.0 mm to 7.0 mm, and a fiber thickness of from 0.5 denier to 30 denier is used.

In the revolving brush 61, the nip length of the fiber into the surface of the electrophotographic photoreceptor 10 is preferably from 0.3 mm to 1.5 mm.

The number of revolution of the revolving brush 61 may be changed according to the circumferential speed of the electrophotographic photoreceptor 10. For example, the relative speed ratio between the revolving brush 61 and the electrophotographic photoreceptor 10 is preferably from 0.5 to 1.5. Further, the rotation direction of the revolving brush 61 may be the same direction as the rotation direction of the electrophotographic photoreceptor 10, or may be the opposite direction from the rotation direction of the electrophotographic photoreceptor 10.

Though not shown, a plate-shaped member that mechanically knocks down the toner adhering to the revolving brush 61 may also be provided.

The supply amount of the lubricant 62 is preferably such that the contact angle with respect to water on the surface of the electrophotographic photoreceptor 10, which is in a state of having been supplied with the lubricant 62, the lubricant being spread by the cleaning blade 72, is 90° or more. Specifically, the supply amount of the lubricant 62 is preferably from 1 μg to 100 μg, and more preferably from 3 μg to 20 μg, per one rotation of the electrophotographic photoreceptor 10.

Here, the supply amount of the lubricant 62 may be adjusted by adjusting, for example, the fiber density on the surface of the revolving brush 61, the length of the fiber, the thickness of the fiber, the material of the fiber, the number of revolution of the revolving brush 61, or the like. Further, the supply amount of the lubricant 62 may be adjusted by changing the pushing pressure of the lubricant 62 against the revolving brush 61. Furthermore, the supply amount of the lubricant 62 may be adjusted by providing a system for attaching the lubricant 62 to the revolving brush 61 and detaching the lubricant 62 from the revolving brush 61, thereby controlling the contacting time of the revolving brush 61 with the lubricant 62.

The contact angle with respect to water is expressed by the value determined as follows. For the measurement, an angle meter (trade name: CA-X, manufactured by Kyowa Interface Science Co., Ltd.) is used. Under an environment of 25° C. and 50% RH, approximately 3.1 μL of pure water are added dropwise onto a measuring object surface, and after 15 seconds have passed from the addition, the contact angle of the liquid droplet is measured. Specifically, the liquid droplet of pure water that has been added dropwise onto the measuring object surface is photographed by using an optical microscope photograph, and the contact angle θ of water is determined from the photograph. For 15 points over the entire region of the measuring object surface (for example, 3 divisions along the circumferential direction and 5 divisions along the axis direction to give 15 points in total), the contact angle of the liquid droplet of pure water is measured, and an average value is determined. The average value determined as described above is let be the contact angle in the exemplary embodiment of the invention.

In the exemplary embodiment of the invention, a configuration provided with a lubricant applying device 60 that supplies a lubricant 62 is explained, but the present invention is not limited thereto. A configuration in which a lubricant applying device 60 is not provided, a lubricant 62 in the form of powder is used as an external additive of a toner, and supply of the lubricant 62 onto a surface of an electrophotographic photoreceptor 10 is performed together with development by a developing device 40 (namely, a configuration in which the developing device 40 serves for the lubricant applying device 60) may also be adopted.

Next, an imaging process (image forming method) using the image forming apparatus 101 according to the exemplary embodiment of the invention is explained.

In the image forming apparatus 101 according to the exemplary embodiment of the invention, first, the surface of the electrophotographic photoreceptor 10 is charged by the charging device 20, while the electrophotographic photoreceptor 10 is rotated along the direction indicated by the arrow a.

The electrophotographic photoreceptor 10 whose surface has been charged by the charging device 20 is exposed by the exposure device 30, to form a latent image on the surface of the electrophotographic photoreceptor.

Next, the portion of the electrophotographic photoreceptor 10 at which the latent image has been formed is conveyed toward the developing device 40. In the developing device 40, a magnetic brush formed on the surface of the developing roll 42 by a developer contacts with the electrophotographic photoreceptor 10, whereby the toner adheres to the latent image, resulting in forming a toner image.

Then, the electrophotographic photoreceptor 10 having the toner image formed thereon is further rotated along the direction indicated by the arrow a, and the toner image is transferred to the surface on the outer surface of intermediate transfer body 50.

When the toner image is transferred to the intermediate transfer body 50, the recording medium P is supplied to the secondary transfer device 52 by the recording paper applying device 53, and the toner image that has been transferred to the intermediate transfer body 50 is transferred onto the recording medium P by the secondary transfer device 52. In this way, the toner image is formed on the recording paper P.

The toner image formed on the recording paper P is fixed by the fixing device 80.

After the toner image has been transferred to the intermediated transfer body 50, the lubricant 62 is supplied to the surface of the electrophotographic photoreceptor 10 by the lubricant applying device 60, and a film of the lubricant 62 is formed on the surface of the electrophotographic photoreceptor 10. Thereafter, the toners or discharge products remaining on the surface are removed by the cleaning blade 72 of the cleaning device 70. The electrophotographic photoreceptor 10, which is cleaned in the cleaning device 70 by removing the toners or discharge products remaining after the transfer, is charged again by the charging device 20 and then, is exposed by the exposure device 30 to form a latent image.

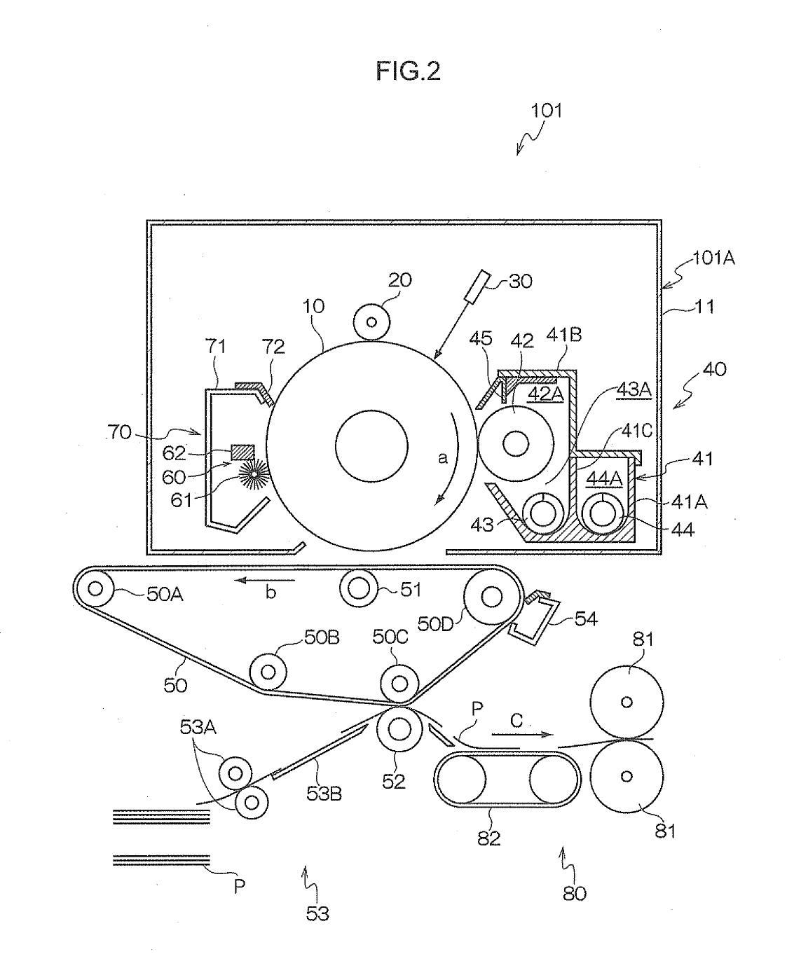

Further, the image forming apparatus 101 according to an exemplary embodiment of the invention may have a configuration equipped with, for example, as shown in FIG. 2, a process cartridge 101A that integrates and stores an electrophotographic photoreceptor 10, a charging device 20, a developing device 40, a lubricant applying device 60, and a cleaning device 70 in a case body 11. This process cartridge 101A stores plural members in an integrated form and is attachable to and detachable from the image forming apparatus 101. Note that, in FIG. 2, an image forming apparatus 101 having a configuration in which a replenishment developer storing container 47 is not provided in the developing device 40 is shown.

The configuration of the process cartridge 101A is not limited thereto. Any configuration is applicable as long as the process cartridge 101A is provided with at least the electrophotographic photoreceptor 10, the developing device 40 and the cleaning device 70. For example, a configuration is also applicable in which the process cartridge 101A is provided with at least one selected from the charging device 20, the exposure device 30, and the primary transferring device 51.

The image forming apparatus 101 according to the exemplary embodiment is not limited to the above configuration. For example, the image forming apparatus 101 may include a first eraser, which aligns the polarities of the residual toners to easily remove the residual toners with the cleaning brush or the like, and which is provided around the electrophotographic photoreceptor 10 at the downstream side of the primary transferring device 51 in the rotation direction of the electrophotographic photoreceptor 10 but at the upstream side of the cleaning device 70 in the rotation direction of the electrophotographic photoreceptor. The image forming apparatus 101 may also include a second eraser, which erases charges on the surface of the electrophotographic photoreceptor 10, and which is provided at the downstream side of the cleaning device 70 in the rotation direction of the electrophotographic photoreceptor but at the upstream side of the charging apparatus 20 in the rotation direction of the electrophotographic photoreceptor.

In addition, the image forming apparatus 101 according to the exemplary embodiment is not limited to the above configuration. A known configuration may be used such as an image forming apparatus for directly transferring the toner image formed on the electrophotographic photoreceptor 10 onto the recording paper P, or a tandem type image forming apparatus.

### EXAMPLES

Hereinafter, the present invention will be further specifically described based on Examples and Comparative Examples. However, the present invention is not limited to the following Examples.

(Method of Measuring Particle Size and Particle Size Distribution)

Measurement of the particle diameter (which may also be referred to as “particle size”) and the particle diameter distribution (which may also be referred to as “particle size distribution”) is performed as follows.

In a case in which the particles to be measured have a diameter of 2 μm or more, COULTER MULTISIZER II (trade name, manufactured by Beckman Coulter Inc.) is used as the measuring apparatus, and ISOTON-II (trade name, manufactured by Beckman Coulter Inc.) is used as the electrolyte liquid.

The measurement procedure is as follows. 0.5 mg to 50 mg of a sample to be measured are added to 2 mL of a 5% aqueous solution of a surfactant, preferably sodium alkylbenzene sulfonate, as a dispersing agent. Then, the resultant is added to 100 mL of the above electrolyte liquid.

The electrolyte liquid containing the sample suspended therein is subjected to a dispersion treatment using an ultrasonic disperser for approximately one minute. Then, the particle size distribution of particles having a particle diameter in a range of from 1 μm to 30 μm is measured by using the above COULTER MULTISIZER II with an aperture diameter of 50 μm, to determine the volume average particle diameter. The number of particles to be measured is 50,000.

The particle size distribution of the toner is measured by the following method. Based on the measured particle size distribution, a volume of the particles is accumulated to draw a cumulative volume curve from the smallest diameter for divided particle size ranges (channels), and the particle diameter corresponding to 16% in the cumulative volume curve is defined as D16v. Further, the particle diameter corresponding to 50% in the cumulative volume curve is defined as D50v. Moreover, the particle diameter corresponding to 84% in the cumulative volume curve is defined as D84v.

The volume average particle diameter in the exemplary embodiment of the invention is expressed by the above D50v. Further, the particle size distribution coefficient GSD is calculated according to the following Equation.

Equation GSD={(D84v)/(D16v)}^{0.5}

In a case in which the particles to be measured have a diameter of less than 2 μm, such as release agent particles, colorant particles, or the like, the measurement is performed by using a laser diffraction type particle size distribution analyzer (trade name: LA-700, manufactured by Horiba Ltd.). The measurement procedure is as follows. Approximately 2 g of the sample in the state of a dispersion liquid, in terms of solids, are weighed, and ion exchanged water is added thereto to give a total amount of approximately 40 mL. Then, the resulting liquid is introduced into a cell until the concentration reaches an appropriate concentration. Then, the cell is left to stand still approximately 2 minutes. When the concentration of the liquid inside the cell becomes almost stable, the measurement is performed. The obtained volume particle diameter for each channel is accumulated from the smallest volume particle diameter to draw a cumulative volume curve, and the particle diameter corresponding to 50% in the cumulative volume curve is defined as the integrated volume particle diameter D50v.

Further, in the case of measuring powder such as an external additive, the measurement procedure is as follows. 2 g of a sample to be measured are added to 50 mL of a 5% aqueous solution of a surfactant, preferably sodium alkylbenzene sulfonate. Then, the resultant is dispersed for 2 minutes using an ultrasonic disperser (at 1,000 Hz). Thereby, a sample is prepared. Then, the particle size distribution of particles is measured in substantially the same manner as that in the case of the dispersion liquid described above.

(Molecular Weight of Polymer in Toner, Resin Particles and Resin Coated Carrier)

The weight-average molecular weight is measured under the following conditions. For example, the GPC apparatus used is HLC-8120GPC, SC-8020 (manufactured by Tosoh Corporation), as the column, two pieces of TSK gel, SuperHM-H (manufactured by Tosoh Corporation, 6.0 mm ID×15 cm) are used, and the eluent is THF (tetrahydrofuran). The experiment is carried out under the following conditions: the sample concentration of 0.5%, flow velocity of 0.6 ml/min, sample injection amount of 10 measuring temperature of 40° C., and R1 (refractive index) detector (differential refractometer). Calibration curve is prepared from ten samples of polystyrene standard samples TSK standards (trade names: A-500, F-1, F-10, F-80, F-380, A-2500, F-4, F-40, F-128, and F-700, manufactured by Tosoh Corporation).

The melting point of the release agent and the glass transition temperature of the binder resin are determined by DSC (differential scanning calorimater) measurement method from the major maximum peak measured in accordance with ASTMD 3418-8. The major maximum peak may be measured by using DSC-7 (trade name; manufactured by PerkinElmer Japan Co., Ltd.). In this apparatus, temperature of a detection unit is corrected by melting point of indium and zinc, and the calorimetric value is corrected by using fusion heat of indium. For the sample, an aluminum pan is used, and for the control, an empty pan is set. Measurement is carried out at an elevating rate of temperature of 10° C./min.

### (Method of Measuring Integrated Volume Particle Diameter (D50v) and (D90v) of Carrier and Magnetic Substance Particles)

With regard to the carrier and the magnetic substance particles, the integrated volume particle diameter (D50v) and (D90v) are expressed by the values measured using a laser diffraction/scattering particle size distribution analyzer (trade name: LS PARTICLE SIZE ANALYZER LS13 320, manufactured by Beckman Coulter). Based on the obtained particle size distribution, a volume of the particles is accumulated to draw a cumulative volume curve from the smallest diameter for divided particle size ranges (channels), and the particle diameter corresponding to 50% in the cumulative volume curve is defined as the 50% integrated volume particle diameter (D50v). Further, based on the obtained particle size distribution, a volume of the particles is accumulated to draw a cumulative volume curve from the smallest diameter for divided particle size ranges (channels), and the particle diameter corresponding to 90% in the cumulative volume curve is defined as the 90% integrated volume particle diameter (D90v).

[Preparation of Toner]

Preparation of Amorphous Polyester Resin (A1) and Amorphous Resin Particle Dispersion Liquid (a1)

15 parts by mol of polyoxyethylene(2,0)-2,2-bis(4-hydroxyphenyl)propane, 85 parts by mol of polyoxyethylene(2,2)-2,2-bis(4-hydroxyphenyl)propane, 10 parts by mol of terephthalic acid, 67 parts by mol of fumaric acid, 3 parts by mol of n-dodecenyl succinic acid, 20 parts by mol of trimellitic acid, and 0.05 parts by mol of dibutyl tin oxide with respect to these acid components (the total mole number of terephthalic acid, n-dodecenyl succinic acid, trimellitic acid, and fumaric acid) are introduced into a two-necked flask which is heated and dried, nitrogen gas is introduced into the flask to maintain the inert gas atmosphere, the temperature is raised, and then a co-condensation polymerization reaction is performed at 150° C. to 230° C. for 12 hours to 20 hours. Thereafter, it is slowly depressurized at 210° C. to 250° C., whereby the amorphous polyester resin (A1) is synthesized. The weight-average molecular weight Mw of the resin is 65,000 and the glass-transition temperature Tg is 65° C.

3,000 parts of the acquired amorphous polyester resin, 10,000 parts of the ion-exchange water, and 90 parts of sodium dodecylbenzenesulfonate surfactant are introduced into an emulsification tank of a high-temperature and high-pressure emulsification device (CAVITRON CD 1010; trade name, slit: 0.4 mm), the resultant is heated and dissolved at 130° C., the resultant is dispersed at 110° C. by 10,000 revolutions at a flow rate of 3 L/m for 30 minutes, and the resultant is made to pass through a cooling tank to recover an amorphous resin particle dispersion liquid (high-temperature and high-pressure emulsification device (CAVITRON CD 1010; trade name, slit: 0.4 mm), whereby an amorphous resin particle dispersion liquid (a1) is acquired.

Preparation of Crystalline Polyester Resin (B1) and Crystalline Resin Particle Dispersion Liquid (b1)

45 parts by mol of 1,9-nonanediol, 55 parts by mol of dodecanedicarboxylic acid, and 0.05 parts by mol of dibutyl tin oxide as a catalyst are introduced into a three-necked flask which is heated and dried, nitrogen gas is introduced into the flask to maintain the air in the flask in the inert gas atmosphere by under reduced pressure, and the resultant is agitated at 180° C. for 2 hours by mechanical agitation. Thereafter, the temperature is slowly raised up to 230° C. under the decompressed pressure, the resultant is agitated for 5 hours, and the resultant is cooled by air in a thickened state, and the reaction is stopped, whereby the crystalline polyester resin (B1) is synthesized. The weight-average molecular weight Mw of the resin is 25,000 and the melting point Tm is 73° C.

Thereafter, the crystalline resin particle dispersion liquid (b1) is acquired using the high-temperature and high-pressure emulsification device (CAVITRON CD1010; trade name, slit: 0.4 mm) under the same condition as preparation of the amorphous resin dispersion liquid (A1).

Preparation of Colorant Particles Dispersion Liquid C1
Cyan pigment Pigment Blue 15:3 (trade name, manufactured by Dainichiseika Color & Chemicals Mfg. Co., Ltd., copper phthalocyanine)): 1000 parts by weight
Anionic surfactant NEOGEN RK (trade name, manufactured by Dai-ichi Kogyo Seiyaku Co., Ltd.): 150 parts by weight
Ion-exchanged water: 4000 parts by weight.

The above-described components are mixed, dissolved, and dispersed for one hour using a high-pressure impact type disperser ultimizer HJP30006 (trade name, manufactured by Sugino Machine Ltd.) to obtain a colorant particles dispersion in which a colorant (cyan pigment) is dispersed. In the obtainedA volume average particle diameter is 0.15 μm, and a content of the colorant particles is 20%.

Preparation of Colorant Particles Dispersion Liquid Y1

Colorant particles dispersion liquid Y1 is prepared in a manner substantially similar to that in the colorant particles dispersion C1 except that the colorant used is replaced with C. I. Pigment Yellow 74 (SEIKAFAST YELLOW 2054; trade name, manufactured by Dainichiseika Color & Chemicals Mfg. Co., Ltd., Monoazo pigment having azo group).

Preparation of Colorant Particles Dispersion Liquid Y2

Colorant particles dispersion liquid Y2 is prepared in a manner substantially similar to that in the colorant particles dispersion C1 except that the colorant used is replaced with C. I. Pigment Yellow 93 (CHROMOFINE YELLOW 5930; trade name, manufactured by Dainichiseika Color & Chemicals Mfg. Co., Ltd., Condensed disazo pigment having azo groups).

Preparation of Colorant Particles Dispersion Liquid Y3

Colorant particles dispersion liquid Y3 is prepared in a manner substantially similar to that in the colorant particles dispersion C1 except that the colorant used is replaced with C. I. Pigment Yellow 193 (CHROMOFINE YELLOW AF-1300; trade name, manufactured by Dainichiseika Color & Chemicals Mfg. Co., Ltd., Anthraquinone based pigment).

Preparation of Colorant Particles Dispersion Liquid Y4

Colorant particles dispersion liquid Y4 is prepared in a manner substantially similar to that in the colorant particles dispersion C1 except that the colorant used is replaced with C. I. Pigment Yellow 17 (KET YELLOW 403; trade name, manufactured by DIC Corporation, Disazo pigment having azo groups).

Preparation of Colorant Particles Dispersion Liquid M1

Colorant particles dispersion liquid M1 is prepared in a manner substantially similar to that in the colorant particles dispersion C1 except that the colorant used is replaced with C. I. Pigment Red 122 (manufactured by Dainichiseika Color & Chemicals Mfg. Co., Ltd., Quinacridone-based pigment).

Preparation of Colorant Particles Dispersion Liquid M2

Colorant particles dispersion liquid M2 is prepared in a manner substantially similar to that in the colorant particles dispersion C1 except that the colorant used is replaced with C. I. Pigment Red 22 (manufactured by DIC Corporation, (3-naphthol-based pigment).

Preparation of Colorant Particles Dispersion Liquid M3

Colorant particles dispersion liquid M3 is prepared in a manner substantially similar to that in the colorant particles dispersion C1 except that the colorant used is replaced with C. I. Pigment Red 57:1 (manufactured by DIC Corporation, Azo lake pigment).

Preparation of Colorant Particles Dispersion Liquid M4

Colorant particles dispersion liquid M4 is prepared in a manner substantially similar to that in the colorant particles dispersion C1 except that the colorant used is replaced with C. I. Pigment Red 37 (MAROON HFM01; trade name, manufactured by Clariant Japan K.K., Disazo pigment).
Preparation of Colorant Particles Dispersion Liquid M5

Colorant particles dispersion liquid MS is prepared in a manner substantially similar to that in the colorant particles dispersion C1 except that the colorant used is replaced with C. I. Pigment Red 144 (CROMOPHTAL RED BRN; trade name, manufactured by Ciba Geigy Ltd., Condensed disazo pigment).

Preparation of Release Agent Particle Dispersion Liquid 1
Wax (WEP-2; trade name, manufactured by NOF CORPORATION, the company name of which is changed in 2007): 100 parts by weight
Anionic surfactant (NEOGEN SC; trade name, manufactured by Dai-Ichi Kogyo Seiyaku Co., Ltd.): 2 parts by weight
Ion-exchanged water: 300 parts by weight

The above materials are mixed and heated at 95° C., are dispersed with a homogenizer (ULTRA TURRAX T50; trade name, manufactured by IKA Corporation), and are then dispersed with a pressure-ejecting GAULIN HOMOGENIZER (trade name, manufactured by GAULIN Corporation), whereby a release agent particle dispersion liquid 1 in which release agent particles (release agent concentration: 20% by weight) are dispersed is prepared.

(Preparation of Toner Base Particles 1 and Toner 1)

Preparation of Toner Base Particles 1
Amorphous resin particle dispersion liquid a1: 340 parts by weight
Crystalline resin particle dispersion liquid b1: 160 parts by weight
Colorant particle dispersion liquid C1: 50 parts by weight
Release agent particle dispersion liquid 1: 60 parts by weight
Surfactant aqueous solution: 10 parts by weight
0.3M nitric acid aqueous solution: 50 parts by weight
Ion-exchanged water: 500 parts by weight

The above components are introduced into a round stainless flask, are dispersed with a homogenizer (ULTRA TURRAX T50; trade name, manufactured by IKA Corporation), and are maintained in a heating oil bath heated up to 42° C. for 30 minutes. Then, the temperature of the heating oil bath is raised up to 58° C., the resultant is maintained therein for 30 minutes, 100 parts by weight of the amorphous resin particle dispersion liquid (a1) is added thereto at the time of confirming that flocculated particles are formed, and the resultant dispersion liquid is maintained in this state for 30 minutes.

Subsequently, a sodium nitrilotriacetate salt (CHELEST 70; trade name, manufactured by CHELEST Corporation) is added thereto to occupy 3% of the total solution. Thereafter, 1N sodium hydroxide aqueous solution is slowly added thereto until the pH reaches 7.2, and the resultant is heated up to 85° C. while maintaining the continuous agitation and is maintained for 3.0 hours. Thereafter, the reaction product is filtrated, and the resultant is washed with the ion-exchanged water and is dried with a vacuum drier, whereby toner base particle 1 is obtained.

The particle diameter of the toner base particle 1 is measured using a Coulter Multisizer, and it is revealed that the integrated volume particle diameter D50v is 4.5 μm and the particle size distribution coefficient GSD is 1.22.

Preparation of External Additive

Silica particles 1 are prepared by a sol-gel method. The silica particles 1 are silica particles surface-treated with hexamethyl disilazane in an amount of surface treatment of 5% by weight and have an average primary particle diameter of 120 nm.

Preparation of Toner 1

3 parts by weight of silica particles 1 and 1 part by weight of silica particles (trade name: 8972, manufactured by NIPPON AEROSIL Co., Ltd.) are added to 100 parts by weight of toner base particles 1. The resultant is mixed for 15 minutes using a 5 liter Henschel mixer at a circumferential speed of 30 m/s, and then coarse particles are removed using a sieve having sieve openings of 45 μm. Thereby, toner 1 is obtained.

### (Preparation of Toner Base Particles 2 and Toner 2)

Toner base particles 2 are prepared in a manner substantially similar to that in the toner base particles 1 except that after adjusting the pH of the resultant dispersion liquid to 7.2, the resultant dispersion liquid is heated up to 83° C. while maintaining the continuous agitation and is maintained for 2.5 hours. The integrated volume particle diameter D50v of the toner base particles 2 is 4.0 μm and the particle size distribution coefficient GSD thereof is 1.22.

Toner 2 is prepared in a manner substantially similar to that in the toner 1 except that the toner base particles 2 are used instead of using the toner base particles 1 in the preparation of the toner 1.

(Preparation of Toner Base Particles 3 and Toner 3)

Toner base particles 3 are prepared in a manner substantially similar to that in the toner base particles 1 except that after adjusting the pH of the resultant dispersion liquid to 7.2, the resultant dispersion liquid is heated up to 87° C. while maintaining the continuous agitation and is maintained for 4.0 hours. The integrated volume particle diameter D50v of the toner base particles 3 is 5.2 μm and the particle size distribution coefficient GSD thereof is 1.22.

Toner 3 is prepared in a manner substantially similar to that in the toner 1 except that the toner base particles 3 are used instead of using the toner base particles 1 in the preparation of the toner 1.

(Preparation of Toner Base Particles 4 and Toner 4)

The components the same as those used in the preparation of toner base particles 1 are introduced into a round stainless-steel flask, are dispersed by using a homogenizer (trade name: ULTRA TURRAX T50, manufactured by IKA Corporation), and are maintained in a heating oil bath heated up to 42° C. for 30 minutes. Then, the temperature of the heating oil bath is further raised up to 54° C., and the resultant is maintained therein for 30 minutes. At the time of confirming that flocculated particles are formed, 100 parts by weight of the amorphous resin particle dispersion liquid (a1) are added thereto, and the resulting mixture is maintained in this state for 30 minutes.

Subsequently, sodium nitrilotriacetate (trade name: CHELEST 70, manufactured by CHELEST Corporation) is added thereto to occupy 3% of the total liquid. Thereafter, a 1N sodium hydroxide aqueous solution is slowly added thereto until the pH reaches 7.2. Then, the resultant is heated up to 83° C. while maintaining the continuous agitation, and is maintained for 2 hours. Thereafter, the reaction product is filtrated, and the resultant is washed with ion exchanged water, and then dried using a vacuum drier, whereby toner base particles 4 are obtained. The integrated volume particle diameter D50v and the particle size distribution coefficient GSD of the toner base particles 4 are 2.8 μn and 1.27, respectively. Further, using the obtained toner base particles 4, toner 4 is prepared in substantially the same manner as that in the preparation of the toner 1 except that the toner base particles 4 are used instead of the toner base particles 1.

(Preparation of Toner Base Particles 5 and Toner 5)

Toner base particles 5 are prepared in a manner substantially similar to that in the toner base particles 4 except that the dispersed components are maintained in a heating oil bath heated up to 56° C. for 30 minutes instead of maintaining in a heating oil bath heated up to 54° C. for 30 minutes. The integrated volume particle diameter D50v of the toner base particles 5 is 3.1 μm and the particle size distribution coefficient GSD thereof is 1.25.

Toner 5 is prepared in a manner substantially similar to that in the toner 1 except that the toner base particles 5 are used instead of using the toner base particles 1 in the preparation of the toner 1.

(Preparation of Toner Base Particles 6 and Toner 6)

Toner base particles 6 are prepared in a manner substantially similar to that in the toner base particles 1 except that after adjusting the pH of the resultant dispersion liquid to 7.2, the resultant dispersion liquid is heated up to 89° C. while maintaining the continuous agitation and is maintained for 3.0 hours. The integrated volume particle diameter D50v of the toner base particles 6 is 5.4 μm and the particle size distribution coefficient GSD thereof is 1.22.

Toner 6 is prepared in a manner substantially similar to that in the toner 1 except that the toner base particles 6 are used instead of using the toner base particles 1 in the preparation of the toner 1.

(Preparation of Toner Base Particles 7 and Toner 7)

Preparation of toner base particles 7 is conducted in a manner substantially similar to that in the preparation of the toner base particles 1, except that the mixed and dispersed components are heated in a heating oil bath up to 48° C. and maintained for 30 minutes, and then the temperature of the heating oil bath is further raised up to 60° C. and the resultant is maintained therein for 30 minutes, instead of heating in a heating oil bath up to 42° C. and maintaining for 30 minutes, and then further raising the temperature of the heating oil bath up to 58° C. and maintaining the resultant therein for 30 minutes. The integrated volume particle diameter D50v and the particle size distribution coefficient GSD of the obtained toner base particles 7 are 5.8 μm and 1.22, respectively.

Further, using the obtained toner base particles 7, toner 7 is prepared in substantially the same manner as that in the preparation of the toner 1.

(Preparation of Toner Base Particles 8 and Toner 8)

Preparation of toner base particles 8 is conducted in substantially the same manner as that in the preparation of the toner base particles 1, except that the mixed and dispersed components are heated in a heating oil bath up to 52° C. and maintained for 30 minutes, and then the temperature of the heating oil bath is further raised up to 61° C. and the resultant is maintained therein for 30 minutes, instead of heating in a heating oil bath up to 42° C. and maintaining for 30 minutes, and then further raising the temperature of the heating oil bath up to 58° C. and maintaining the resultant therein for 30 minutes. The integrated volume particle diameter D50v and the particle size distribution coefficient GSD of the obtained toner base particles 8 are 6.2 μm and 1.26, respectively.

Further, using the obtained toner base particles 8, toner 8 is prepared in substantially the same manner as that in the preparation of the toner 1.

(Preparation of Toner Base Particles 9 to 16 and Toners 9 to 16)

Preparation of toner base particles 9 to 16 and toners 9 to 16 is conducted in substantially the same manner as that in the preparation of the toner base particles 1 to 8 and toners 1 to 8, except that the colorant particle dispersion liquid (Y1) is used instead of using the colorant particle dispersion liquid (C1) in the preparation of the toner base particles 1 to 8 and toners 1 to 8.

(Preparation of Toner Base Particles 17 and Toner 17)

Preparation of toner base particles 17 and toner 17 is conducted in a manner substantially similar to that in the preparation of the toner base particles 1 and toner 1, except that the colorant particle dispersion liquid (Y2) is used instead of using the colorant particle dispersion liquid (C1) in the preparation of the toner base particles 1 and toner 1.

(Preparation of Toner Base Particles 18 and Toner 18)

Preparation of toner base particles 18 and toner 18 is conducted in a manner substantially similar to that in the preparation of the toner base particles 1 and toner 1, except that the colorant particle dispersion liquid (Y3) is used instead of using the colorant particle dispersion liquid (C1) in the preparation of the toner base particles 1 and toner 1.

(Preparation of Toner Base Particles 19 and Toner 19)

Preparation of toner base particles 19 and toner 19 is conducted in a manner substantially similar to that in the preparation of the toner base particles 1 and toner 1, except that the colorant particle dispersion liquid (Y4) is used instead of using the colorant particle dispersion liquid (C1) in the preparation of the toner base particles 1 and toner 1.

(Preparation of Toner Base Particles 20 to 27 and Toners 20 to 27)

Preparation of toner base particles 20 to 27 and toners 20 to 27 is conducted in a manner substantially similar to that in the preparation of the toner base particles 1 to 8 and toners 1 to 8, except that the colorant particle dispersion liquid (M1) is used instead of using the colorant particle dispersion liquid (C1) in the preparation of the toner base particles 1 to 8 and toners 1 to 8.

(Preparation of Toner Base Particles 28 and Toner 28)

Preparation of toner base particles 28 and toner 28 is conducted in a manner substantially similar to that in the preparation of the toner base particles 1 and toner 1, except that the colorant particle dispersion liquid (M2) is used instead of using the colorant particle dispersion liquid (C1) in the preparation of the toner base particles 1 and toner 1.

(Preparation of Toner Base Particles 29 and Toner 29)

Preparation of toner base particles 29 and toner 29 is conducted in a manner substantially similar to that in the preparation of the toner base particles 1 and toner 1, except that the colorant particle dispersion liquid (M3) is used instead of using the colorant particle dispersion liquid (C1) in the preparation of the toner base particles 1 and toner 1.

(Preparation of Toner Base Particles 30 and Toner 30)

Preparation of toner base particles 30 and toner 30 is conducted in a manner substantially similar to that in the preparation of the toner base particles 1 and toner 1, except that the colorant particle dispersion liquid (M4) is used instead of using the colorant particle dispersion liquid (C1) in the preparation of the toner base particles 1 and toner 1.

(Preparation of Toner Base Particles 31 and Toner 31)

Preparation of toner base particles 31 and toner 31 is conducted in a manner substantially similar to that in the preparation of the toner base particles 1 and toner 1, except that the colorant particle dispersion liquid (M5) is used instead of using the colorant particle dispersion liquid (C1) in the preparation of the toner base particles 1 and toner 1.

The properties of the toners 1 to 31 are listed in Table 1.

[Preparation of Carrier]

(Carrier 1)

Preparation of Magnetic Substance Particles 1 (Core Material)

70 parts by weight of Fe₂O₃, 22.5 parts by weight of MnO₂, and 0.011 parts by weight of CuO are mixed, and the mixture is subjected to mixing/grinding for 30 hours using a wet ball mill. Then, the resultant is granulated and dried using a spray dryer, and then subjected to temporary calcination 1 at 850° C. for 7 hours using a rotary kiln. The thus obtained temporarily calcined substance 1 is ground for 2 hours using a wet ball mill, so that the integrated volume particle diameter D50v reaches 2.1 μm. Thereafter, the resultant is further granulated and dried using a spray dryer, and then subjected to temporary calcination 2 at 910° C. for 6 hours using a rotary kiln. The thus obtained temporarily calcined substance 2 is ground for 4.8 hours using a wet ball mill, so that the integrated volume particle diameter D50v reaches 5.5 μm. Further, the resultant is further granulated and dried using a spray dryer, and then subjected to regular calcination at 950° C. for 14 hours using an electric oven. The product is subjected to a crushing process and a classifying process, to obtain magnetic substance particles 1 having an integrated volume particle diameter D50v of 24.3 μm, a magnetization of 59 AM²/kg when the magnetic field is 1 kOe, and a specific gravity of 4.5.

Preparation of Carrier 1

1,000 parts by weight of the magnetic substance particles 1, and 150 parts by weight of PMMA (polymethyl methacrylate; weight average molecular weight of 75,000) solution (solids concentration of 20%) manufactured by Soken Chemical & Engineering Co., Ltd. are introduced into a kneader, and mixed at 70° C. for 20 minutes. Thereafter, the resulting mixture is dried under a reduced pressure and further stirred for 20 minutes to remove the solvent. Thereby, a resin coated carrier is obtained. The resin coated carrier thus obtained is sieved by using a sieve having sieve openings of 45 μm, to remove coarse powder. In this way, carrier 1 is obtained.

The obtained carrier 1 has D50v of 26.3 μm, D90v of 34.3 μm, and a magnetization of 57 AM²/kg.

(Carrier 2)

Preparation of Magnetic Substance Particles 2 (Core Material)

The temporarily calcined substance 1 in the magnetic substance particles 1 is ground for 2 hours using a wet ball mill, so that the integrated volume particle diameter D50v reaches 2.1 μm. Thereafter, the resultant is further granulated and dried using a spray dryer, and then subjected to temporary calcination 2 at 870° C. for 6 hours using a rotary kiln. The thus obtained temporarily calcined substance 2 is ground for 4.8 hours using a wet ball mill, so that the integrated volume particle diameter D50v reaches 5.5 μm. Further, the resultant is further granulated and dried using a spray dryer, and then subjected to regular calcination at 900° C. for 16 hours using an electric oven. The product is subjected to a crushing process and a classifying process, to obtain magnetic substance particles 2 having an integrated volume particle diameter D50v of 29.8 μm, a magnetization of 54 AM²/kg when the magnetic field is 1 kOe, and a specific gravity of 4.5.

Preparation of Carrier 2

Carrier 2 is prepared in a manner substantially similar to that in the carrier 1 except that the magnetic substance particles 2 are used instead of using the magnetic substance particles 1 in the preparation of the carrier 1. A 50% integrated volume particle diameter D50v and a 90% integrated volume particle diameter D90v of the obtained carrier 2 are 30.3 μm and 38.5 μm, respectively, and a magnetization thereof is 52 AM²/kg when the magnetic field is 1 kOe.

(Carrier 3)

Preparation of Magnetic Substance Particles 3 (Core Material)

70 parts by weight of Fe₂O₃, 22.5 parts by weight of MnO₂, and 0.011 parts by weight of CuO are mixed, and the mixture is subjected to mixing/grinding for 30 hours using a wet ball mill. Then, the resultant is granulated and dried using a spray dryer, and then subjected to temporary calcination 1 at 800° C. for 7 hours using a rotary kiln. The thus obtained temporarily calcined substance 1 is ground for 2 hours using a wet ball mill, so that the integrated volume particle diameter D50v reaches 2.1 μm. Thereafter, the resultant is further granulated and dried using a spray dryer, and then subjected to temporary calcination 2 at 840° C. for 6 hours using a rotary kiln. The thus obtained temporarily calcined substance 2 is ground for 8 hours using a wet ball mill, so that the integrated volume particle diameter D50v reaches 4.5 μm. Further, the resultant is further granulated and dried using a spray dryer, and then subjected to regular calcination at 850° C. for 16 hours using an electric oven. The product is subjected to a crushing process and a classifying process, to obtain magnetic substance particles 3 having an integrated volume particle diameter D50v of 16.9 μm, a magnetization of 42 AM²/kg when the magnetic field is 1 kOe, and a specific gravity of 4.5.

Preparation of Carrier 3

Carrier 3 is prepared in a manner substantially similar to that in the carrier 1 except that the magnetic substance particles 3 are used instead of using the magnetic substance particles 1 in the preparation of the carrier 1. A 50% integrated volume particle diameter D50v and a 90% integrated volume particle diameter D90v of the obtained carrier 3 are 17.9 μm and 23.1 μm, respectively, and a magnetization thereof is 38 AM²/kg when the magnetic field is 1 kOe.

(Carrier 4)

Preparation of Magnetic Substance Particles 4 (Core Material)

The temporarily calcined substance 1 in the magnetic substance particles 1 is ground for 2 hours using a wet ball mill, so that the integrated volume particle diameter D50v reaches 2.1 μm. Thereafter, the resultant is further granulated and dried using a spray dryer, and then subjected to temporary calcination 2 at 890° C. for 6 hours using a rotary kiln. The thus obtained temporarily calcined substance 2 is ground for 4.8 hours using a wet ball mill, so that the integrated volume particle diameter D50v reaches 5.5 μm. Further, the resultant is further granulated and dried using a spray dryer, and then subjected to regular calcination at 910° C. for 14 hours using an electric oven. The product is subjected to a crushing process and a classifying process, to obtain magnetic substance particles 4 having an integrated volume particle diameter D50v of 25.2 μm, a magnetization of 57 AM²/kg when the magnetic field is 1 kOe, and a specific gravity of 4.5.

Preparation of Carrier 4

Carrier 4 is prepared in a manner substantially similar to that in the carrier 1 except that the magnetic substance particles 4 are used and the resulting mixture is dried under a reduced pressure and further stirred for 10 minutes, instead of using the magnetic substance particles 1 and stirring for 20 minutes in the preparation of the carrier 1. A 50% integrated volume particle diameter D50v and a 90% integrated volume particle diameter D90v of the obtained carrier 2 are 30.3 μm and 38.5 μm, respectively, and a magnetization thereof is 52 AM²/kg when the magnetic field is 1 kOe.

Preparation of Carrier 5

Carrier 5 is prepared in a manner substantially similar to that in the carrier 1 except that the obtained resin coated carrier is sieved by using a sieve having sieve openings of 32 μm instead of using the sieve having sieve openings of 45 μm in the preparation of the carrier 1. A 50% integrated volume particle diameter D50v and a 90% integrated volume particle diameter D90v of the obtained carrier 5 are 25.6 μm and 30.5 μm, respectively, and a magnetization thereof is 55 AM²/kg when the magnetic field is 1 kOe.

(Carrier 6)

Preparation of Magnetic Substance Particles 6 (Core Material)

500 parts by weight of spherical magnetite particles having a size of 0.3 μm are introduced into a Henschel mixer and are sufficiently stirred. Thereafter, 5.0 parts by weight of titanate-based coupling agent are added thereto. Then, the resultant is heated to approximately 95° C. and is sufficiently mixed by stirring for 30 minutes. Thereby, spherical magnetite particles coated with a titanate-based coupling agent are obtained.

Separately, 60 parts of weight of phenol, 90 parts by weight of a 37% by weight formalin, 500 parts by weight of the above magnetite particles subjected to a lipophilic treatment, 16 parts by weight of a 28% by weight ammonia water, and 50 parts by weight of water are introduced into a 1 L four-necked flask, and mixed by stirring. Then, the resulting mixture is heated to 85° C. over 60 minutes, which is stirred, and at the temperature, the resulting mixture is allowed to react for 180 minutes. Thereafter, the contents of the flask are cooled to 25° C., and 500 mL of water is added thereto. Then, a supernatant liquid is removed therefrom, and a remaining precipitate is washed with water and dried at 130° C. under a reduced pressure. In this way, magnetic substance particles 6 (resin particles in which fine magnetic powders are dispersed (MPDR)) having a particle diameter of 28.7 μm and a true specific gravity of 3.5 are obtained.

Preparation of Carrier 6

Using the magnetic substance particles 6, carrier 6 is prepared in substantially the same manner as that in the preparation of the carrier 1.

The obtained carrier 6 has D50v of 30.3 μm, D90v of 36.0 μm, and a magnetization of 60 AM²/kg.

(Carrier 7)

Preparation of Carrier 7

The carrier 3 is treated with an Elbow Jet classifier (manufactured by Nittetsu Mining Co., Ltd.; item number: EJ-LABO) at a cut point of 18 μm to classify the fine powder side, whereby carrier 7 is obtained.

The obtained carrier 7 has D50v of 15.2 μm, D90v of 21.0 μm, and a magnetization of 38 AM²/kg.

(Carrier 8)

Preparation of Carrier 8

The carrier 1 is treated with an Elbow Jet classifier (manufactured by Nittetsu Mining Co., Ltd.; item number: EJ-LABO) at a cut point of 31 μm to classify the coarse powder side, whereby carrier 8 is obtained.

The obtained carrier 8 has D50v of 35.2 μm, D90v of 44.9 μm, and a magnetization of 57 AM²/kg.

Preparation of Carrier 9

The carrier 4 is treated with an Elbow Jet classifier (manufactured by Nittetsu Mining Co., Ltd.; item number: EJ-LABO) at a cut point of 29 μm to classify the coarse powder side, whereby carrier 9 is obtained. A 50% integrated volume particle diameter D50v and a 90% integrated volume particle diameter D90v of the obtained carrier 9 are 32.0 μm and 42.8 μm, respectively, and a magnetization thereof is 68 AM²/kg when the magnetic field is 1 kOe.

Preparation of Carrier 10

Magnetic substance particles 10 is prepared in a manner substantially similar to that in the magnetic substance particles 1 except 0.015 parts by weight of CuO is used instead of using 0.011 parts by weight of CuO in the preparation of the magnetic substance particles 1. Carrier 10 is prepared in a manner substantially similar to that in the carrier 1 except that the magnetic substance particles 10 are used instead of using the magnetic substance particles 1 in the preparation of the carrier 1. A 50% integrated volume particle diameter D50v and a 90% integrated volume particle diameter D90v of the obtained carrier 10 are 26.4 μm and 34.0 μm, respectively, and a magnetization thereof is 57 AM²/kg when the magnetic field is 1 kOe.

Preparation of Carrier 11

Magnetic substance particles 11 is prepared in a manner substantially similar to that in the magnetic substance particles 1 except 0.055 parts by weight of CuO is used instead of using 0.011 parts by weight of CuO in the preparation of the magnetic substance particles 1. Carrier 11 is prepared in a manner substantially similar to that in the carrier 1 except that the magnetic substance particles 11 are used instead of using the magnetic substance particles 1 in the preparation of the carrier 1. A 50% integrated volume particle diameter D50v and a 90% integrated volume particle diameter D90v of the obtained carrier 11 are 26.5 μm and 35.0 μm, respectively, and a magnetization thereof is 57 AM²/kg when the magnetic field is 1 kOe.

Preparation of Carrier 12

Magnetic substance particles 12 is prepared in a manner substantially similar to that in the magnetic substance particles 1 except 0.060 parts by weight of CuO is used instead of using 0.011 parts by weight of CuO in the preparation of the magnetic substance particles 1. Carrier 12 is prepared in a manner substantially similar to that in the carrier 1 except that the magnetic substance particles 12 are used instead of using the magnetic substance particles 1 in the preparation of the carrier 1. A 50% integrated volume particle diameter D50v and a 90% integrated volume particle diameter D90v of the obtained carrier 12 are 26.2 μm and 35.2 μm, respectively, and a magnetization thereof is 57 AM²/kg when the magnetic field is 1 kOe.

Preparation of Carrier 13

Magnetic substance particles 13 is prepared in a manner substantially similar to that in the magnetic substance particles 1 except 0.110 parts by weight of CuO is used instead of using 0.011 parts by weight of CuO in the preparation of the magnetic substance particles 1. Carrier 13 is prepared in a manner substantially similar to that in the carrier 1 except that the magnetic substance particles 13 are used instead of using the magnetic substance particles 1 in the preparation of the carrier 1. A 50% integrated volume particle diameter D50v and a 90% integrated volume particle diameter D90v of the obtained carrier 13 are 26.3 μm and 35.5 μm, respectively, and a magnetization thereof is 57 AM²/kg when the magnetic field is 1 kOe.

Preparation of Carrier 14

Magnetic substance particles 14 is prepared in a manner substantially similar to that in the magnetic substance particles 1 except 0.120 parts by weight of CuO is used instead of using 0.011 parts by weight of CuO in the preparation of the magnetic substance particles 1. Carrier 14 is prepared in a manner substantially similar to that in the carrier 1 except that the magnetic substance particles 14 are used instead of using the magnetic substance particles 1 in the preparation of the carrier 1. A 50% integrated volume particle diameter D50v and a 90% integrated volume particle diameter D90v of the obtained carrier 14 are 26.0 μm and 34.8 μm, respectively, and a magnetization thereof is 57 AM²/kg when the magnetic field is 1 kOe.

The properties of the prepared carriers are summarized in Table 2.

### Examples 1 to 67 and Comparative Examples 1 to 36

According to the combination shown in Tables 3 to 8, 4 parts by weight of the toner and 96 parts by weight of the carrier are stirred for 5 minutes using a V-blender, whereby respective developers are obtained.

The developer thus obtained is charged in a developer container of an image forming apparatus, “modified machine of DOCUCENTRE COLOR 500 (trade name, manufactured by Fuji Xerox Co., Ltd.), and respective evaluations are performed. The evaluation results are shown in Tables 3 to 8.

Note that, in Comparative Examples 12, 24, and 36, the supply of the lubricant to the photoreceptor is not conducted.

In the modified machine, the machine is modified so that the lubricant applying device is placed in the cleaning device at the upstream side of the cleaning blade in the rotation direction of the photoreceptor.

The setting conditions of the devices are as described below. Here, the number range and condition in the parentheses in the setting conditions of the devices indicate the range of conditions which gives at least the same evaluation results.

(Evaluation)

Contact Angle with Respect to Water on Surface of Photoreceptor

Evaluation of the initial contact angle with respect to water on the surface of the photoreceptor is performed as follows. A unit prepared by removing a developing unit from an image forming unit, namely, a unit including only a photoreceptor, a cleaning device, and a lubricant applying device is used to perform initial coating of coating the surface of the photoreceptor with the lubricant. Evaluations are performed after adjusting the initial value of the contact angle with respect to water on the surface of the photoreceptor to approximately 95°.

Further, concerning the contact angle over time with respect to water on the surface of the photoreceptor, image output is performed on 50,000 sheets, and with regard to the 50,000th sheet, the contact angle is measured.

Fog

Evaluation of fog is performed as follows.

After image output is carried out on 50,000 sheets, formation of blank images is carried out, and in the middle of the image formation process, the image forming apparatus is made to stop. Thereafter, the image on the portion between the development region and the primary transfer region on the photoreceptor is transferred on a tape, and the tape is pasted on a paper sheet (trade name: OK TOPCOAT PLUS, manufactured by Oji Paper Co., Ltd.). The density of the image on the tape and the density of the paper sheet are measured by using a densitometer (trade name: X-RITE 938, manufactured by X-Rite Inc.). The difference in density: (Density of the image on the tape−Density of the paper sheet), is let be the evaluation density difference, which is evaluated according to the evaluation criteria described below. Note that, the grade B at the stage of 50,000 sheets is deemed as practically acceptable. Thereafter, the evaluation of fog is continued for every 10,000th sheet until the 100,000th sheet. At the stage in which the evaluation density difference is evaluated as grade C, the evaluation is stopped.

The evaluation criteria are as follows.

AA: The density difference is less than 0.05.

A: The density difference is 0.05 or more but less than 0.1.

B: The density difference is 0.1 or more but less than 0.2.

C: The density difference exceeds 0.2.

Carrier Scattering

Evaluation of carrier scattering is performed as follows.

After image output is carried out on 50,000 sheets, formation of blank images is carried out, and in the middle of the image formation process, the image forming apparatus is made to stop. Thereafter, the image on the portion between the development region and the primary transfer region on the photoreceptor is transferred on a tape having a size of 2.5 cm×40 cm, and the tape is pasted on a paper sheet (trade name: OK TOPCOAT PLUS, manufactured by Fuji Xerox Co., Ltd.). The number of carrier particles on the tape is counted, and the result is converted to a number per an area of A3-size from the area ratio. The above measurement is repeated three times, and the average number is determined. Using the correlation between the average number and a sensorial value, evaluation is performed according to the following criteria.

The evaluation criteria are as follows.

AA: Carrier scattering can not be recognized.

A: Carrier scattering can be recognized, but there is no uncomfortable feeling.

B: Carrier scattering can be recognized, but it is acceptable.

C: Unacceptable.

Toner Image Disorder

Evaluation of toner image disorder is performed as follows.

After image output is carried out on 50,000 sheets, formation of a half-tone image is carried out. Evaluation is performed by comparing the half-tone image with a limit sample showing the following sensorial value.

The evaluation criteria are as follows.

AA: Toner image disorder can not be recognized.

A: Toner image disorder can be recognized, but there is no uncomfortable feeling.

B: Toner image disorder can be recognized, but it is acceptable.

C: Unacceptable.

Here, in a case in which at least one of the results of the evaluations of carrier scattering and toner image disorder is evaluated as grade C at the stage of 50,000 sheets, the evaluation of fog after 50,000 sheets is not carried out, regardless of the result of the evaluation of fog.

(Setting Conditions of Devices)

Conditions for Supplying Lubricant

The lubricant applying device is provided with a revolving brush that is arranged so as to be in contact with the electrophotographic photoreceptor, and a solid state lubricant that is arranged so as to be in contact with the revolving brush, and a flicker (a plate-shaped member) that mechanically knocks down the toner adhering to the revolving brush. The details thereof are as follows.
Lubricant: a mixture of 95% by weight of zinc stearate and 5% by weight of PTFE.
Revolving brush: the material thereof is an electrically conductive nylon (trade name: BELTRON, available from TSUCHIYA CO., LTD.; fiber thickness of 3 denier); the fiber density is 50 kf/inch², the nip length of the revolving brush to the electrophotographic photoreceptor is 0.5 mm; the outside diameter is Φ12 mm; and the shaft diameter is Φ6 mm.
Driving conditions of the revolving brush: the shaft is earthed; the rotation direction is the same as the rotation direction of the electrophotographic photoreceptor; the rotating speed is 1.2 times as large as the rotating speed of the electrophotographic photoreceptor.
Flicker (plate-shaped member): a propylene resin board having a thickness of 0.5 mm (the nip length of the flicker to the revolving brush is 0.5 mm.)
Supply amount of the lubricant: 10 μg per one rotation of the electrophotographic photoreceptor (from 3 μg to 20 μg)

Cleaning Conditions
Rubber hardness of the cleaning blade: 80° (from 70° to 85°)
Rubber impact resilience of the cleaning blade: 45% (from 20% to 55%)
Angle of contact of the cleaning blade with respect to the photoreceptor: 20° (from 10° to 30°)
Line pressure of the cleaning blade with respect to the photoreceptor: 3 gf/mm (from 2 gf/mm to 4 gf/mm)

Development Conditions
Distance between the developing roll and the opposing photoreceptor (DRS): 300 μm (from 200 μm to 600 μm)
Amount of the developer (MOS) on the developing roll: 400 g/m² (from 200 g/m² to 600 g/m²)
Rotation speed of the developing roll (processing speed): 330 mm/sec (from 50 mm/sec to 1500 mm/sec)
Rotation direction (MRS) of the developing roll: the same direction (“with” direction) as the rotation direction of the photoreceptor, at a peripheral speed ratio of 1.7 (the same direction (“with” direction) as the rotation direction of the photoreceptor, at a peripheral speed ratio of from 1.0 to 3.0, or the opposite direction (“against” direction) from the rotation direction of the photoreceptor at a peripheral speed ratio of from 0.6 to 2.0).
Form and roughness of the surface of the developing roll: sand blast Rz of 25 μm (from 10 μm to 50 μm), groove sleeves with 2 mm pitch (from 0.2 mm pitch to 2 mm pitch)
Diameter of the developing roll: Φ18 mm (from Φ10 mm to Φ40 mm)
Development polar magnetic force on the developing roller: 125 mT (millitesla, from 50 mT to 150 mT)
Magnet set angle (MSA) of the developing roll: at the upstream side, 3° (from −10° to +10°)
Direct current component voltage in the voltage to be applied to the developing roll: −525 V (from −600 V to −450 V)
Difference between the direct current component voltage in the voltage to be applied to the developing roll and the photoreceptor surface voltage that corresponds to the background portion of the image (Vein): 125V (from 50 V to 200 V)
Wave form of the alternating current component voltage (developing AC bias) that is superposed on the direct current component voltage (DC) to be applied to the developing roll: sine wave (rectangular wave)
Amplitude of the developing AC bias (Vp-p: peak to peak voltage): 1.75 kV (from 0 kV to 2.0 kV)
Occupying proportion of the alternating current component voltage to the applied voltage (developing AC bias duty) 50% (from 20% to 80%)
Frequency of the developing AC bias: 10 kHz (from 3 kHz to 40 kHz)

TABLE 1
Properties of Toner

| | Kind of | | Integrated | |
|---|---|---|---|---|
| | Colorant | | volume particle | |
| | dispersion | | diameter | |
| | liquid | Kind of Colorant | D50v (μm) | GSD |
| Toner 1 | C1 | Copper phthalocyanine | 4.5 | 1.22 |
| Toner 2 | C1 | Copper phthalocyanine | 4.0 | 1.22 |
| Toner 3 | C1 | Copper phthalocyanine | 5.2 | 1.22 |
| Toner 4 | C1 | Copper phthalocyanine | 2.8 | 1.27 |
| Toner 5 | C1 | Copper phthalocyanine | 3.1 | 1.25 |
| Toner 6 | C1 | Copper phthalocyanine | 5.4 | 1.22 |
| Toner 7 | C1 | Copper phthalocyanine | 5.8 | 1.22 |
| Toner 8 | C1 | Copper phthalocyanine | 6.2 | 1.26 |
| Toner 9 | Y1 | Monoazo | 4.4 | 1.21 |
| Toner 10 | Y1 | Monoazo | 4.0 | 1.22 |
| Toner 11 | Y1 | Monoazo | 5.2 | 1.21 |
| Toner 12 | Y1 | Monoazo | 2.8 | 1.27 |
| Toner 13 | Y1 | Monoazo | 3.1 | 1.25 |
| Toner 14 | Y1 | Monoazo | 5.4 | 1.22 |
| Toner 15 | Y1 | Monoazo | 5.9 | 1.21 |
| Toner 16 | Y1 | Monoazo | 6.2 | 1.26 |
| Toner 17 | Y2 | Condensed disazo | 4.5 | 1.22 |
| Toner 18 | Y3 | Anthraquinone | 4.5 | 1.23 |
| Toner 19 | Y4 | Disazo | 4.5 | 1.21 |
| Toner 20 | M1 | Quinacridone | 4.4 | 1.21 |
| Toner 21 | M1 | Quinacridone | 4.1 | 1.21 |
| Toner 22 | M1 | Quinacridone | 5.3 | 1.21 |
| Toner 23 | M1 | Quinacridone | 2.8 | 1.26 |
| Toner 24 | M1 | Quinacridone | 3.2 | 1.21 |
| Toner 25 | M1 | Quinacridone | 5.5 | 1.21 |
| Toner 26 | M1 | Quinacridone | 5.8 | 1.20 |
| Toner 27 | M1 | Quinacridone | 6.3 | 1.26 |
| Toner 28 | M2 | β-naphthol | 4.4 | 1.21 |
| Toner 29 | M3 | Azo lake | 4.5 | 1.21 |
| Toner 30 | M4 | Disazo | 4.3 | 1.21 |
| Toner 31 | M5 | Condensed disazo | 4.2 | 1.21 |

TABLE 2
- Properties of Carrier -

| | Average magnetization | | | Magnetization of | Absolute | Cu amount | Carrier | Carrier |
|---|---|---|---|---|---|---|---|---|
| | per one Carrier particle | Carrier | Core | Core material | specific gravity | in Carrier | D50v | D90v |
| | (AM²/one particle) | D90v/D50v | material | (AM²/kg) | (g/cm³) | (ppm) | (μm) | (μm) |
| Carrier 1 | 2.4 · 10⁻¹⁵ | 1.30 | Ferrite | 57 | 4.5 | 95 | 26.3 | 34.3 |
| Carrier 2 | 3.8 · 10⁻¹⁵ | 1.27 | Ferrite | 52 | 4.5 | 95 | 30.3 | 38.5 |
| Carrier 3 | 5.4 · 10⁻¹⁶ | 1.29 | Ferrite | 38 | 4.5 | 95 | 17.9 | 23.1 |
| Carrier 4 | 2.4 · 10⁻¹⁵ | 1.42 | Ferrite | 55 | 4.5 | 95 | 26.6 | 37.8 |
| Carrier 5 | 2.2 · 10⁻¹³ | 1.19 | Ferrite | 55 | 4.5 | 95 | 25.6 | 30.5 |
| Carrier 6 | 3.1 · 10⁻¹⁵ | 1.19 | MPDR | 60 | 3.5 | 15 | 30.3 | 36.0 |
| Carrier 7 | 3.1 · 10⁻¹⁶ | 1.38 | Ferrite | 38 | 4.5 | 95 | 15.2 | 21.0 |
| Carrier 8 | 5.9 · 10⁻¹⁵ | 1.28 | Ferrite | 57 | 4.5 | 95 | 35.2 | 44.9 |
| Carrier 9 | 5.4 · 10⁻¹⁵ | 1.34 | Ferrite | 68 | 4.5 | 95 | 32.0 | 42.8 |
| Carrier 10 | 2.4 · 10⁻¹⁵ | 1.29 | Ferrite | 57 | 4.5 | 130 | 26.4 | 34.0 |
| Carrier 11 | 2.4 · 10⁻¹⁵ | 1.32 | Ferrite | 57 | 4.5 | 480 | 26.5 | 35.0 |
| Carrier 12 | 2.4 · 10⁻¹⁵ | 1.34 | Ferrite | 57 | 4.5 | 520 | 26.2 | 35.2 |
| Carrier 13 | 2.4 · 10⁻¹⁵ | 1.35 | Ferrite | 57 | 4.5 | 950 | 26.3 | 35.5 |
| Carrier 14 | 2.4 · 10⁻¹⁵ | 1.34 | Ferrite | 57 | 4.5 | 1040 | 26.0 | 34.8 |

TABLE 3

| | | | | CAPRS | | Fog | | | | | | Carrier | |
|---|---|---|---|---|---|---|---|---|---|---|---|---|---|
| | Developer | | Lubricant | | 50000^{th} | 50000^{th} | 60000^{th} | 70000^{th} | 80000^{th} | 90000^{th} | 100000^{th} | scatter- | |
| | Toner | Carrier | feed | First | sheet | sheet | sheet | sheet | sheet | sheet | sheet | ing | DTI |
| Exp. 1 | 1 | 1 | feed | 96 | 102 | AA | AA | AA | AA | A | A | AA | AA |
| Exp. 2 | 2 | 1 | feed | 96 | 101 | AA | AA | AA | AA | A | A | AA | AA |
| Exp. 3 | 3 | 1 | feed | 96 | 102 | AA | AA | AA | A | A | A | AA | AA |
| Exp. 4 | 5 | 1 | feed | 96 | 101 | A | A | A | B | B | C | AA | AA |
| Exp. 5 | 6 | 1 | feed | 95 | 102 | B | B | B | C | — | — | AA | AA |
| Exp. 6 | 7 | 1 | feed | 96 | 102 | B | B | C | — | — | — | AA | AA |
| Exp. 7 | 7 | 3 | feed | 95 | 109 | B | B | C | — | — | — | B | AA |
| Exp. 8 | 7 | 2 | feed | 94 | 91 | B | B | C | — | — | — | A | B |
| Exp. 9 | 5 | 3 | feed | 96 | 109 | A | A | B | B | C | — | B | AA |
| Exp. 10 | 5 | 2 | feed | 93 | 91 | A | A | B | B | C | — | A | B |
| Exp. 11 | 1 | 2 | feed | 94 | 91 | AA | AA | AA | AA | A | A | A | B |
| Exp. 12 | 1 | 3 | feed | 94 | 108 | AA | AA | AA | AA | A | A | B | AA |
| Exp. 13 | 1 | 4 | feed | 94 | 98 | AA | AA | AA | A | A | A | AA | AA |
| Exp. 14 | 1 | 5 | feed | 95 | 101 | AA | AA | AA | AA | A | A | AA | AA |
| Exp. 15 | 1 | 6 | feed | 96 | 95 | AA | AA | AA | AA | A | A | AA | A |
| Exp. 16 | 1 | 10 | feed | 96 | 102 | AA | AA | AA | A | A | A | AA | AA |
| Exp. 17 | 1 | 11 | feed | 96 | 102 | AA | AA | AA | A | A | A | AA | AA |
| Exp. 18 | 1 | 12 | feed | 96 | 102 | AA | AA | A | A | A | A | AA | AA |
| Exp. 19 | 1 | 13 | feed | 96 | 102 | AA | AA | A | A | A | A | AA | AA |
| Exp. 20 | 1 | 14 | feed | 96 | 102 | A | A | A | A | B | B | AA | AA |

TABLE 4

| | | | | CAPRS | | Fog | | | | | | Carrier | |
|---|---|---|---|---|---|---|---|---|---|---|---|---|---|
| | Developer | | Lubricant | | 50000^{th} | 50000^{th} | 60000^{th} | 70000^{th} | 80000^{th} | 90000^{th} | 100000^{th} | scatter- | |
| | Toner | Carrier | feed | First | sheet | sheet | sheet | sheet | sheet | sheet | sheet | ing | DTI |
| Comp. | 1 | 7 | feed | 96 | 111 | AA | — | — | — | — | — | C | AA |
| Exp. 1 | | | | | | | | | | | | | |
| Comp. | 1 | 8 | feed | 95 | 82 | AA | — | — | — | — | — | AA | C |
| Exp. 2 | | | | | | | | | | | | | |
| Comp. | 1 | 9 | feed | 94 | 80 | AA | — | — | — | — | — | AA | C |
| Exp. 3 | | | | | | | | | | | | | |
| Comp. | 5 | 7 | feed | 96 | 111 | B | — | — | — | — | — | C | AA |
| Exp. 4 | | | | | | | | | | | | | |
| Comp. | 7 | 7 | feed | 96 | 110 | B | — | — | — | — | — | C | AA |
| Exp. 5 | | | | | | | | | | | | | |
| Comp. | 4 | 3 | feed | 95 | 109 | C | — | — | — | — | — | B | AA |
| Exp. 6 | | | | | | | | | | | | | |
| Comp. | 4 | 2 | feed | 95 | 92 | C | — | — | — | — | — | A | B |
| Exp. 7 | | | | | | | | | | | | | |
| Comp. | 5 | 9 | feed | 94 | 80 | B | — | — | — | — | — | AA | C |
| Exp. 8 | | | | | | | | | | | | | |
| Comp. | 7 | 9 | feed | 94 | 80 | B | — | — | — | — | — | AA | C |
| Exp. 9 | | | | | | | | | | | | | |
| Comp. | 8 | 2 | feed | 95 | 91 | C | — | — | — | — | — | A | B |
| Exp. 10 | | | | | | | | | | | | | |
| Comp. | 8 | 3 | feed | 96 | 109 | C | — | — | — | — | — | B | AA |
| Exp. 11 | | | | | | | | | | | | | |
| Comp. | 1 | 1 | non | 76 | 78 | C | — | — | — | — | — | A | A |
| Exp. 12 | | | | | | | | | | | | | |

TABLE 5

| | | | | CAPRS | | Fog | | | | | | Carrier | |
|---|---|---|---|---|---|---|---|---|---|---|---|---|---|
| | Developer | | Lubricant | | 50000^{th} | 50000^{th} | 60000^{th} | 70000^{th} | 80000^{th} | 90000^{th} | 100000^{th} | scatter- | |
| | Toner | Carrier | feed | First | sheet | sheet | sheet | sheet | sheet | sheet | sheet | ing | DTI |
| Exp. 21 | 9 | 1 | feed | 96 | 102 | AA | AA | AA | AA | AA | A | AA | AA |
| Exp. 22 | 10 | 1 | feed | 96 | 101 | AA | AA | AA | AA | AA | A | AA | AA |
| Exp. 23 | 11 | 1 | feed | 96 | 102 | AA | AA | AA | AA | A | A | AA | AA |
| Exp. 24 | 13 | 1 | feed | 96 | 101 | A | A | A | B | B | B | AA | AA |
| Exp. 25 | 14 | 1 | feed | 95 | 102 | B | B | B | B | C | — | AA | AA |
| Exp. 26 | 15 | 1 | feed | 96 | 102 | B | B | B | C | — | — | AA | AA |
| Exp. 27 | 15 | 3 | feed | 95 | 109 | B | B | B | C | — | — | B | AA |
| Exp. 28 | 15 | 2 | feed | 94 | 91 | B | B | B | C | — | — | A | B |
| Exp. 29 | 13 | 3 | feed | 96 | 109 | A | A | B | B | B | C | B | AA |
| Exp. 30 | 13 | 2 | feed | 93 | 91 | A | A | B | B | B | C | A | B |
| Exp. 31 | 9 | 2 | feed | 94 | 91 | AA | AA | AA | AA | AA | A | A | B |
| Exp. 32 | 9 | 3 | feed | 94 | 108 | AA | AA | AA | AA | AA | A | B | AA |
| Exp. 33 | 9 | 4 | feed | 94 | 98 | AA | AA | AA | AA | A | A | AA | AA |
| Exp. 34 | 9 | 5 | feed | 95 | 101 | AA | AA | AA | AA | AA | A | AA | AA |
| Exp. 35 | 9 | 6 | feed | 96 | 95 | AA | AA | AA | AA | AA | A | AA | A |
| Exp. 36 | 9 | 10 | feed | 96 | 102 | AA | AA | AA | AA | A | A | AA | AA |
| Exp. 37 | 9 | 11 | feed | 96 | 102 | AA | AA | AA | AA | A | A | AA | AA |
| Exp. 38 | 9 | 12 | feed | 96 | 102 | AA | AA | AA | A | A | A | AA | AA |
| Exp. 39 | 9 | 13 | feed | 96 | 102 | AA | AA | AA | A | A | A | AA | AA |
| Exp. 40 | 9 | 14 | feed | 96 | 102 | A | A | A | A | A | B | AA | AA |
| Exp. 41 | 17 | 1 | feed | 96 | 102 | AA | AA | AA | AA | AA | A | AA | AA |
| Exp. 42 | 18 | 1 | feed | 96 | 102 | AA | AA | AA | AA | AA | A | AA | AA |
| Exp. 43 | 19 | 1 | feed | 96 | 102 | AA | AA | AA | AA | AA | A | AA | AA |

TABLE 6

| | | | | CAPRS | | Fog | | | | | | Carrier | |
|---|---|---|---|---|---|---|---|---|---|---|---|---|---|
| | Developer | | Lubricant | | 50000^{th} | 50000^{th} | 60000^{th} | 70000^{th} | 80000^{th} | 90000^{th} | 100000^{th} | scatter- | |
| | Toner | Carrier | feed | First | sheet | sheet | sheet | sheet | sheet | sheet | sheet | ing | DTI |
| Comp. | 9 | 7 | feed | 96 | 111 | AA | — | — | — | — | — | C | AA |
| Exp. 13 | | | | | | | | | | | | | |
| Comp. | 9 | 8 | feed | 95 | 82 | AA | — | — | — | — | — | AA | C |
| Exp. 14 | | | | | | | | | | | | | |
| Comp. | 9 | 9 | feed | 94 | 80 | AA | — | — | — | — | — | AA | C |
| Exp. 15 | | | | | | | | | | | | | |
| Comp. | 13 | 7 | feed | 96 | 111 | B | — | — | — | — | — | C | AA |
| Exp. 16 | | | | | | | | | | | | | |
| Comp. | 15 | 7 | feed | 96 | 110 | B | — | — | — | — | — | C | AA |
| Exp. 17 | | | | | | | | | | | | | |
| Comp. | 12 | 3 | feed | 95 | 109 | C | — | — | — | — | — | B | AA |
| Exp. 18 | | | | | | | | | | | | | |
| Comp. | 12 | 2 | feed | 95 | 92 | C | — | — | — | — | — | A | B |
| Exp. 19 | | | | | | | | | | | | | |
| Comp. | 13 | 9 | feed | 94 | 80 | B | — | — | — | — | — | AA | C |
| Exp. 20 | | | | | | | | | | | | | |
| Comp. | 15 | 9 | feed | 94 | 80 | B | — | — | — | — | — | AA | C |
| Exp. 21 | | | | | | | | | | | | | |
| Comp, | 16 | 2 | feed | 95 | 91 | C | — | — | — | — | — | A | B |
| Exp. 22 | | | | | | | | | | | | | |
| Comp. | 16 | 3 | feed | 96 | 109 | C | — | — | — | — | — | B | AA |
| Exp. 23 | | | | | | | | | | | | | |
| Comp. | 9 | 1 | non | 76 | 78 | C | — | — | — | — | — | A | A |
| Exp. 24 | | | | | | | | | | | | | |

TABLE 7

| | | | | CAPRS | | Fog | | | | | | Carrier | |
|---|---|---|---|---|---|---|---|---|---|---|---|---|---|
| | Developer | | Lubricant | | 50000^{th} | 50000^{th} | 60000^{th} | 70000^{th} | 80000^{th} | 90000^{th} | 100000^{th} | scatter- | |
| | Toner | Carrier | feed | First | sheet | sheet | sheet | sheet | sheet | sheet | sheet | ing | DTI |
| Exp. 44 | 20 | 1 | feed | 96 | 102 | AA | AA | AA | AA | AA | A | AA | AA |
| Exp. 45 | 21 | 1 | feed | 96 | 101 | AA | AA | AA | AA | AA | A | AA | AA |
| Exp. 46 | 22 | 1 | feed | 96 | 102 | AA | AA | AA | AA | A | A | AA | AA |
| Exp. 47 | 24 | 1 | feed | 96 | 101 | A | A | A | B | B | B | AA | AA |
| Exp. 48 | 25 | 1 | feed | 95 | 102 | B | B | B | B | C | — | AA | AA |
| Exp. 49 | 26 | 1 | feed | 96 | 102 | B | B | B | C | — | — | AA | AA |
| Exp. 50 | 26 | 3 | feed | 95 | 109 | B | B | B | C | — | — | B | AA |
| Exp. 51 | 26 | 2 | feed | 94 | 91 | B | B | B | C | — | — | A | B |
| Exp. 52 | 24 | 3 | feed | 96 | 109 | A | A | B | B | B | C | B | AA |
| Exp. 53 | 24 | 2 | feed | 93 | 91 | A | A | B | B | B | C | A | B |
| Exp. 54 | 20 | 2 | feed | 94 | 91 | AA | AA | AA | AA | AA | A | A | B |
| Exp. 55 | 20 | 3 | feed | 94 | 108 | AA | AA | AA | AA | AA | A | B | AA |
| Exp. 56 | 20 | 4 | feed | 94 | 98 | AA | AA | AA | AA | A | A | AA | AA |
| Exp. 57 | 20 | 5 | feed | 95 | 101 | AA | AA | AA | AA | AA | A | AA | AA |
| Exp. 58 | 20 | 6 | feed | 96 | 95 | AA | AA | AA | AA | AA | A | AA | A |
| Exp. 59 | 20 | 10 | feed | 96 | 102 | AA | AA | AA | AA | A | A | AA | AA |
| Exp. 60 | 20 | 11 | feed | 96 | 102 | AA | AA | AA | AA | A | A | AA | AA |
| Exp. 61 | 20 | 12 | feed | 96 | 102 | AA | AA | AA | A | A | A | AA | AA |
| Exp. 62 | 20 | 13 | feed | 96 | 102 | AA | AA | AA | A | A | A | AA | AA |
| Exp. 63 | 20 | 14 | feed | 96 | 102 | A | A | A | A | A | B | AA | AA |
| Exp. 64 | 28 | 1 | feed | 96 | 102 | AA | AA | AA | AA | AA | A | AA | AA |
| Exp. 65 | 29 | 1 | feed | 96 | 99 | AA | AA | AA | AA | A | A | AA | AA |
| Exp. 66 | 30 | 1 | feed | 96 | 102 | AA | AA | AA | AA | AA | A | AA | AA |
| Exp. 67 | 31 | 1 | feed | 96 | 102 | AA | AA | AA | AA | AA | A | AA | AA |

TABLE 8

| | | | | CAPRS | | Fog | | | | | | Carrier | |
|---|---|---|---|---|---|---|---|---|---|---|---|---|---|
| | Developer | | Lubricant | | 50000^{th} | 50000^{th} | 60000^{th} | 70000^{th} | 80000^{th} | 90000^{th} | 100000^{th} | scatter- | |
| | Toner | Carrier | feed | First | sheet | sheet | sheet | sheet | sheet | sheet | sheet | ing | DTI |
| Comp. | 20 | 7 | feed | 96 | 111 | AA | — | — | — | — | — | C | AA |
| Exp. 25 | | | | | | | | | | | | | |
| Comp. | 20 | 8 | feed | 95 | 82 | AA | — | — | — | — | — | AA | C |
| Exp. 26 | | | | | | | | | | | | | |
| Comp. | 20 | 9 | feed | 94 | 80 | AA | — | — | — | — | — | AA | C |
| Exp. 27 | | | | | | | | | | | | | |
| Comp. | 24 | 7 | feed | 96 | 111 | B | — | — | — | — | — | C | AA |
| Exp. 28 | | | | | | | | | | | | | |
| Comp. | 26 | 7 | feed | 96 | 110 | B | — | — | — | — | — | C | AA |
| Exp. 29 | | | | | | | | | | | | | |
| Comp. | 23 | 3 | feed | 95 | 109 | C | — | — | — | — | — | B | AA |
| Exp. 30 | | | | | | | | | | | | | |
| Comp. | 23 | 2 | feed | 95 | 92 | C | — | — | — | — | — | A | B |
| Exp. 31 | | | | | | | | | | | | | |
| Comp. | 24 | 9 | feed | 94 | 80 | B | — | — | — | — | — | AA | C |
| Exp. 32 | | | | | | | | | | | | | |
| Comp. | 26 | 9 | feed | 94 | 80 | B | — | — | — | — | — | AA | C |
| Exp. 33 | | | | | | | | | | | | | |
| Comp. | 27 | 2 | feed | 95 | 91 | C | — | — | — | — | — | A | B |
| Exp. 34 | | | | | | | | | | | | | |
| Comp. | 27 | 3 | feed | 96 | 109 | C | — | — | — | — | — | B | AA |
| Exp. 35 | | | | | | | | | | | | | |
| Comp. | 20 | 1 | non | 76 | 78 | C | — | — | — | — | — | A | A |
| Exp. 36 | | | | | | | | | | | | | |

In tables 3 to 8, the abbreviation “DTI” denotes “Deterioration of toner image”.

From the results described above, it is understood that Examples give good results in the evaluation of fog, as compared with Comparative Examples.

Particularly, it is understood that Examples 21 to 43 which include a yellow toner and Examples 44 to 67 which include a magenta toner are a little more effective against fog than Examples 1 to 20 which include a cyan toner.

Further, it is understood that it is more effective against fog, as the amount of copper elements in the carrier is smaller.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic latent image developer used in an image forming apparatus comprising:
an image holding member;
a charging unit that charges a surface of the image holding member;
a latent image forming unit that exposes the charged surface of the image holding member to form an electrostatic latent image;
a developing unit that stores the electrostatic latent image developer and comprises a developer holding member, the developing unit developing the electrostatic latent image formed on the image holding member by bringing a magnetic brush, which is formed on a surface of the developer holding member by the electrostatic latent image developer, into contact with the image holding member, to form a toner image;
a transfer unit that transfers the toner image formed on the image holding member to a recording medium;
a cleaning unit comprising a cleaning blade that contacts with the surface of the image holding member and cleans the surface of the image holding member; and
a lubricant applying unit that supplies a lubricant onto the surface of the image holding member,
the electrostatic latent image developer containing a toner having a 50% integrated volume particle diameter (D50v) of from approximately 3.0 μm to approximately 6.0 μm, and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted.

2. The electrostatic latent image developer according to claim 1, wherein the toner comprises toner particles containing a binder resin, a colorant, a release agent, and hydrophobicized silica particles as an external additive.

3. The electrostatic latent image developer according to claim 2, wherein the binder resin comprises an amorphous polyester and a crystalline resin.

4. The electrostatic latent image developer according to claim 1, wherein a 50% integrated volume particle diameter (D50v) of the carrier particles is in a range from approximately 15 μm to approximately 35 μm.

5. The electrostatic latent image developer according to claim 1, wherein a ratio (D90v/D50v) of a 90% integrated volume particle diameter (D90v) of the carrier particles to a 50% integrated volume particle diameter (D50v) of the carrier particles is in a range from approximately 1.2 to approximately 1.4.

6. The electrostatic latent image developer according to claim 1, wherein the carrier comprises magnetic powder particles coated with resin.

7. The electrostatic latent image developer according to claim 6, wherein the magnetic powder comprises a magnetic metal or a magnetic metal oxide.

8. The electrostatic latent image developer according to claim 7, wherein the magnetic metal oxide comprises ferrite, ferric oxide, or magnetite.

9. The electrostatic latent image developer according to claim 1, wherein the lubricant is selected from the group consisting of zinc stearate, calcium stearate, and low-molecular weight and high density polyethylene having a weight average molecular weight of 3,000 or less and a density of 0.96 or higher.

10. An image forming apparatus comprising:
an image holding member;
a charging unit that charges a surface of the image holding member;
a latent image forming unit that exposes the charged surface of the image holding member to form an electrostatic latent image;
a developing unit that stores an electrostatic latent image developer containing a toner having a 50% integrated volume particle diameter (D50v) of from approximately 3.0 μm to approximately 6.0 μm and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted, and comprises a developer holding member, the developing unit developing the electrostatic latent image formed on the image holding member by bringing a magnetic brush, which is formed on a surface of the developer holding member by the electrostatic latent image developer, into contact with the image holding member, to form a toner image;
a transfer unit that transfers the toner image formed on the image holding member to a recording medium;
a cleaning unit comprising a cleaning blade which contacts with the surface of the image holding member and cleans the surface of the image holding member; and
a lubricant applying unit that supplies a lubricant onto the surface of the image holding member.

11. A process cartridge comprising:
an image holding member;
a developing unit that stores an electrostatic latent image developer containing a toner having a 50% integrated volume particle diameter (D50v) of from approximately 3.0 μm to approximately 6.0 μm and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted, and includes a developer holding member, the developing unit developing an electrostatic latent image formed on the image holding member by bringing a magnetic brush, which is formed on a surface of the developer holding member by the electrostatic latent image developer, into contact with the image holding member, to form a toner image;
a cleaning unit comprising a cleaning blade that contacts with the surface of the image holding member and cleans the surface of the image holding member; and
a lubricant applying unit that supplies a lubricant onto the surface of the image holding member,
the process cartridge being attachable to and detachable from an image forming apparatus.

12. An image forming method comprising:
charging a surface of an image holding member;
exposing the charged surface of the image holding member to form an electrostatic latent image;
forming a magnetic brush on a developer holding member by using an electrostatic latent image developer containing a toner having a 50% integrated volume particle diameter (D50v) of from approximately 3.0 μm to approximately 6.0 μm and a carrier having a mean magnetization per one carrier particle of from approximately 5.0×10⁻¹⁶ AM²/particle to approximately 4.0×10⁻¹⁵ AM²/particle in an applied magnetic field of 1 kilo-oersted, and bringing the magnetic brush into contact with the image holding member to develop the electrostatic latent image formed on the image holding member, thereby forming a toner image;
transferring the toner image formed on the image holding member to a recording medium;
cleaning the surface of the image holding member by using a cleaning blade; and
supplying a lubricant onto the surface of the image holding member.
